(19) United States
(12) Patent Application Publication
(10) Pub. No.: US 2025/0113399 A1
(43) Pub. Date: Apr. 3, 2025

(54) UNICAST AIR-TO-EVERYTHING (A2X) COMMUNICATIONS

(71) Applicant: QUALCOMM Incorporated, San Diego, CA (US)

(72) Inventors: Le LIU, San Jose, CA (US); Qing LI, PRINCETON JUNCTION, NJ (US); Sunghoon KIM, San Diego, CA (US); Alberto RICO ALVARINO, San Diego, CA (US); Stefano FACCIN, San Ysidro, CA (US); Vishnu Vardhan CHETLUR RAVI, San Diego, CA (US); Umesh PHUYAL, San Diego, CA (US)

(21) Appl. No.: 18/775,922

(22) Filed: Jul. 17, 2024

Related U.S. Application Data
(60) Provisional application No. 63/586,330, filed on Sep. 28, 2023.

(51) Int. Cl. H04W 76/14; H04W 4/12; H04W 88/06

(52) U.S. Cl. CPC H04W 76/14; H04W 4/12; H04W 88/06

(57) ABSTRACT

Methods, systems, and devices for wireless communication are described. A user equipment (UE), such as an unmanned aerial vehicle (UAV) (e.g., a source UAV), may initiate a unicast link establishment procedure with another UAV (e.g., a target UAV), which may enable the UAVs to communicate according to an air-to-everything (A2X) service type. The source UAV may transmit a direct communication request (DCR) message to the target UAV that includes an application-layer identifier (ID) that is unique to the target UAV. The source UAV may derive the application-layer ID for the target UAV from a UE-specific ID that is unique to the target UAV. Alternatively, the source UAV may transmit a DCR message that excludes target UAV information. Instead, the DCR message may indicate one or more proximity parameters associated with the source UAV. The UAVs may communicate unicast messages via the unicast link according to A2X configurations and communication parameters.

### CROSS REFERENCE

The present application for patent claims the benefit of U.S. Patent Application No. 63/586,330 by Liu et al. entitled “UNICAST AIR-TO-EVERYTHING (A2X) COMMUNICATIONS,” filed Sep. 28, 2023, which is assigned to the assignee hereof and is expressly incorporated by reference herein.

### FIELD OF TECHNOLOGY

The following relates to wireless communication, including unicast air-to-everything (A2X) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications support communications between wireless devices (e.g., UEs), which are referred to as sidelink communications. For example, some wireless communications systems support vehicle-to-everything (V2X) communications, in which vehicles (e.g., UEs) in a system can communicate with other wireless devices, including roadside infrastructure such as roadside units. Some wireless communications systems may also include unmanned aerial vehicles (UAVs) which support UAV services. UAVs may implement detect and avoid (DAA) systems and techniques that support collision or conflict avoidance.

### SUMMARY

The described techniques relate to improved methods, systems, devices, and apparatuses that support unicast air-to-everything (A2X) communications. For example, the described techniques provide for a user equipment (UE), such as an unmanned aerial vehicle (UAV), to initiate a unicast link establishment procedure with another UAV, which may enable the UAVs to communicate unicast messages with one another according to an A2X service type. Additionally, the described techniques support A2X configurations and communication parameters for communicating the unicast messages via the unicast link. The initiating UAV may be referred to as a source UAV and the UAV with which the source UAV establishes the unicast link may be referred to as a target UAV. In some examples, the source UAV may transmit a direct communication request (DCR) message to the target UAV that includes an application-layer identifier (ID) that is unique to the target UAV. The source UAV may derive the application-layer ID for the target UAV from a UE-specific ID that is unique to the target UAV, and may indicate the application-layer ID in the DCR message. In response to receiving the DCR message, the target UAV may establish security with the source UAV by transmitting a link establishment message to the source UAV.

In other examples, the source UAV may transmit a DCR message that excludes target UAV information. Instead, the source UAV may indicate, in the DCR message, one or more proximity parameters that enable a receiving UAV to determine a relative proximity of the source UAV to the receiving UAV. The one or more proximity parameters may include a position, velocity, heading direction, or the like, of the source UAV, and the receiving UAV may determine a distance between the source UAV and the receiving UAV to use for estimating a possibility (e.g., a probability, a likelihood) of collision with the source UAV. Additionally, or alternatively, the one or more proximity parameters may include a transmit power of the DCR message, an energy per resource element (EPRE) of a reference signal included in the DCR message, or the like, and the receiving UAV may determine a path loss associated with the source UAV. If the distance or the path loss satisfy a threshold, the receiving UAV may proceed with the link establishment procedure with the source UAV.

A method for wireless communication by a first UE is described. The method may include receiving, from a second UE, a broadcast message that includes a UE-specific ID that is unique to the second UE for an unmanned aircraft systems (UAS) traffic management (UTM) system, transmitting a DCR message to the second UE in response to the broadcast message, where the DCR message includes an application-layer ID derived from the UE-specific ID included in the broadcast message, a service type associated with information for communication with the first UE, or both, and communicating unicast messages according to the service type with the second UE based on transmitting the DCR message to the second UE.

A first UE for wireless communication is described. The first UE may include one or more memories storing processor executable code, and one or more processors coupled with the one or more memories. The one or more processors may individually or collectively operable to execute the code to cause the first UE to receive, from a second UE, a broadcast message that includes a UE-specific ID that is unique to the second UE for a UTM system, transmit a DCR message to the second UE in response to the broadcast message, where the DCR message includes an application-layer ID derived from the UE-specific ID included in the broadcast message, a service type associated with information for communication with the first UE, or both, and communicate unicast messages according to the service type with the second UE based on transmitting the DCR message to the second UE.

Another first UE for wireless communication is described. The first UE may include means for receiving, from a second UE, a broadcast message that includes a UE-specific ID that is unique to the second UE for a UTM system, means for transmitting a DCR message to the second UE in response to the broadcast message, where the DCR message includes an application-layer ID derived from the UE-specific ID included in the broadcast message, a service type associated with information for communication with the first UE, or both, and means for communicating unicast messages according to the service type with the second UE based on transmitting the DCR message to the second UE.

A non-transitory computer-readable medium storing code for wireless communication is described. The code may include instructions executable by a processor to receive, from a second UE, a broadcast message that includes a UE-specific ID that is unique to the second UE for a UTM system, transmit a DCR message to the second UE in response to the broadcast message, where the DCR message includes an application-layer ID derived from the UE-specific ID included in the broadcast message, a service type associated with information for communication with the first UE, or both, and communicate unicast messages according to the service type with the second UE based on transmitting the DCR message to the second UE.

In some examples of the method, first UEs, and non-transitory computer-readable medium described herein, the service type includes an A2X service type.

In some examples of the method, first UEs, and non-transitory computer-readable medium described herein, the broadcast message may be a broadcast DAA message that further includes one or more positioning parameters associated with the second UE, the one or more positioning parameters including a position of the second UE, a velocity of the second UE, a heading direction of the second UE, or a combination thereof.

In some examples of the method, first UEs, and non-transitory computer-readable medium described herein, the DCR message may be transmitted to the second UE based on a metric determined from a trajectory of the second UE and the one or more positioning parameters associated with the second UE satisfying a threshold.

In some examples of the method, first UEs, and non-transitory computer-readable medium described herein, the DCR message may be transmitted as part of a unicast link establishment procedure with the second UE.

In some examples of the method, first UEs, and non-transitory computer-readable medium described herein, at least one unicast message of the unicast messages includes a unicast detect and avoid (DAA) message.

In some examples of the method, first UEs, and non-transitory computer-readable medium described herein, the UE-specific ID includes a civil aviation administration (CAA) level ID that identifies the second UE.

A method for wireless communication by a second UE is described. The method may include transmitting, to a first UE, a broadcast message that includes a UE-specific ID that is unique to the second UE for a UTM system, receiving a DCR message from the first UE in response to the broadcast message, where the DCR message includes an application-layer ID derived from the UE-specific ID included in the broadcast message, a service type associated with information for communication with the first UE, or both, and communicating unicast messages according to the service type with the first UE based on receiving the DCR message from the second UE.

A second UE for wireless communication is described. The second UE may include one or more memories storing processor executable code, and one or more processors coupled with the one or more memories. The one or more processors may individually or collectively operable to execute the code to cause the second UE to transmit, to a first UE, a broadcast message that includes a UE-specific ID that is unique to the second UE for a UTM system, receive a DCR message from the first UE in response to the broadcast message, where the DCR message includes an application-layer ID derived from the UE-specific ID included in the broadcast message, a service type associated with information for communication with the first UE, or both, and communicate unicast messages according to the service type with the first UE based on receiving the DCR message from the second UE.

Another second UE for wireless communication is described. The second UE may include means for transmitting, to a first UE, a broadcast message that includes a UE-specific ID that is unique to the second UE for a UTM system, means for receiving a DCR message from the first UE in response to the broadcast message, where the DCR message includes an application-layer ID derived from the UE-specific ID included in the broadcast message, a service type associated with information for communication with the first UE, or both, and means for communicating unicast messages according to the service type with the first UE based on receiving the DCR message from the second UE.

A non-transitory computer-readable medium storing code for wireless communication is described. The code may include instructions executable by a processor to transmit, to a first UE, a broadcast message that includes a UE-specific ID that is unique to the second UE for a UTM system, receive a DCR message from the first UE in response to the broadcast message, where the DCR message includes an application-layer ID derived from the UE-specific ID included in the broadcast message, a service type associated with information for communication with the first UE, or both, and communicate unicast messages according to the service type with the first UE based on receiving the DCR message from the second UE.

In some examples of the method, second UEs, and non-transitory computer-readable medium described herein, the service type includes an A2X service type.

In some examples of the method, second UEs, and non-transitory computer-readable medium described herein, the broadcast message may be a broadcast DAA message that further includes one or more positioning parameters associated with the second UE, the one or more positioning parameters including a position of the second UE, a velocity of the second UE, a heading direction of the second UE, or a combination thereof.

In some examples of the method, second UEs, and non-transitory computer-readable medium described herein, the DCR message may be received as part of a unicast link establishment procedure with the first UE.

In some examples of the method, second UEs, and non-transitory computer-readable medium described herein, at least one unicast message of the unicast messages includes a unicast DAA message.

In some examples of the method, second UEs, and non-transitory computer-readable medium described herein, the UE-specific ID includes a CAA-level ID that identifies the second UE.

A method for wireless communication by a first UE is described. The method may include transmitting a DCR message associated with a service type that includes one or more proximity parameters associated with the first UE, receiving, from a second UE in response to the DCR message, a link establishment message based on a metric determined from a trajectory of the second UE and the one or more proximity parameters associated with the first UE satisfying a threshold, and communicating unicast messages with the second UE according to the service type based on receiving the link establishment message from the second UE.

A first UE for wireless communication is described. The first UE may include one or more memories storing processor executable code, and one or more processors coupled with the one or more memories. The one or more processors may individually or collectively operable to execute the code to cause the first UE to transmit a DCR message associated with a service type that includes one or more proximity parameters associated with the first UE, receive, from a second UE in response to the DCR message, a link establishment message based on a metric determined from a trajectory of the second UE and the one or more proximity parameters associated with the first UE satisfying a threshold, and communicate unicast messages with the second UE according to the service type based on receiving the link establishment message from the second UE.

Another first UE for wireless communication is described. The first UE may include means for transmitting a DCR message associated with a service type that includes one or more proximity parameters associated with the first UE, means for receiving, from a second UE in response to the DCR message, a link establishment message based on a metric determined from a trajectory of the second UE and the one or more proximity parameters associated with the first UE satisfying a threshold, and means for communicating unicast messages with the second UE according to the service type based on receiving the link establishment message from the second UE.

A non-transitory computer-readable medium storing code for wireless communication is described. The code may include instructions executable by a processor to transmit a DCR message associated with a service type that includes one or more proximity parameters associated with the first UE, receive, from a second UE in response to the DCR message, a link establishment message based on a metric determined from a trajectory of the second UE and the one or more proximity parameters associated with the first UE satisfying a threshold, and communicate unicast messages with the second UE according to the service type based on receiving the link establishment message from the second UE.

In some examples of the method, first UEs, and non-transitory computer-readable medium described herein, the service type includes an A2X service type.

In some examples of the method, first UEs, and non-transitory computer-readable medium described herein, the one or more proximity parameters associated with the first UE include a position of the first UE, a velocity of the first UE, a heading direction of the first UE, or a combination thereof and the threshold includes a distance threshold.

In some examples of the method, first UEs, and non-transitory computer-readable medium described herein, the one or more proximity parameters associated with the first UE include a transmit power of the DCR message, an energy per resource element (EPRE) of a reference signal included in the DCR message, or a combination thereof and the threshold includes a path loss threshold.

Some examples of the method, first UEs, and non-transitory computer-readable medium described herein may further include operations, features, means, or instructions for transmitting a broadcast message that includes a set of positioning parameters associated with the first UE and a CAA-level ID that identifies the first UE, where the one or more proximity parameters associated with the first UE include an application-layer ID that may be unique to the first UE, the application-layer ID associated with a service type and derived from the CAA-level ID included in the broadcast message.

Some examples of the method, first UEs, and non-transitory computer-readable medium described herein may further include operations, features, means, or instructions for receiving one or more broadcast messages from one or more other UEs, where each broadcast message of the one or more broadcast messages includes a UE-specific ID and a set of proximity parameters associated with a respective UE of the one or more other UEs, and where the DCR message may be transmitted as part of a unicast link establishment procedure with the second UE.

In some examples of the method, first UEs, and non-transitory computer-readable medium described herein, the UE-specific ID includes a CAA-level ID that identifies the second UE.

In some examples of the method, first UEs, and non-transitory computer-readable medium described herein, the one or more broadcast messages include one or more broadcast DAA messages.

In some examples of the method, first UEs, and non-transitory computer-readable medium described herein, the DCR message excludes an application-layer ID associated with the service type.

In some examples of the method, first UEs, and non-transitory computer-readable medium described herein, at least one unicast message of the unicast messages includes a unicast DAA message.

A method for wireless communication by a second UE is described. The method may include transmitting a broadcast message that includes a UE-specific ID that is unique to the second UE for a UTM system, receiving, from a first UE in response to the broadcast message, a DCR message associated with a service type that includes one or more proximity parameters associated with the first UE, transmitting, to the first UE in response to the DCR message, a link establishment message based on a metric determined from a trajectory of the second UE and the one or more proximity parameters associated with the first UE satisfying a threshold, and communicating unicast messages with the first UE according to the service type based on transmitting the link establishment message to the first UE.

A second UE for wireless communication is described. The second UE may include one or more memories storing processor executable code, and one or more processors coupled with the one or more memories. The one or more processors may individually or collectively operable to execute the code to cause the second UE to transmit a broadcast message that includes a UE-specific ID that is unique to the second UE for a UTM system, receive, from a first UE in response to the broadcast message, a DCR message associated with a service type that includes one or more proximity parameters associated with the first UE, transmit, to the first UE in response to the DCR message, a link establishment message based on a metric determined from a trajectory of the second UE and the one or more proximity parameters associated with the first UE satisfying a threshold, and communicate unicast messages with the first UE according to the service type based on transmitting the link establishment message to the first UE.

Another second UE for wireless communication is described. The second UE may include means for transmitting a broadcast message that includes a UE-specific ID that is unique to the second UE for a UTM system, means for receiving, from a first UE in response to the broadcast message, a DCR message associated with a service type that includes one or more proximity parameters associated with the first UE, means for transmitting, to the first UE in response to the DCR message, a link establishment message based on a metric determined from a trajectory of the second UE and the one or more proximity parameters associated with the first UE satisfying a threshold, and means for communicating unicast messages with the first UE according to the service type based on transmitting the link establishment message to the first UE.

A non-transitory computer-readable medium storing code for wireless communication is described. The code may include instructions executable by a processor to transmit a broadcast message that includes a UE-specific ID that is unique to the second UE for a UTM system, receive, from a first UE in response to the broadcast message, a DCR message associated with a service type that includes one or more proximity parameters associated with the first UE, transmit, to the first UE in response to the DCR message, a link establishment message based on a metric determined from a trajectory of the second UE and the one or more proximity parameters associated with the first UE satisfying a threshold, and communicate unicast messages with the first UE according to the service type based on transmitting the link establishment message to the first UE.

In some examples of the method, second UEs, and non-transitory computer-readable medium described herein, the service type includes an A2X service type.

In some examples of the method, second UEs, and non-transitory computer-readable medium described herein, the one or more proximity parameters associated with the first UE include a position of the first UE and the method, apparatuses, and non-transitory computer-readable medium may include further operations, features, means, or instructions for determining the metric including a distance between the first UE and the second UE, where the threshold includes a distance threshold.

In some examples of the method, second UEs, and non-transitory computer-readable medium described herein, the one or more proximity parameters associated with the first UE include a transmit power of the DCR message and the method, apparatuses, and non-transitory computer-readable medium may include further operations, features, means, or instructions for measuring a reference signal received power (RSRP) associated with receiving the DCR message and determining the metric including a path loss associated with the DCR message based on the RSRP and the one or more proximity parameters, where the threshold includes a path loss threshold.

Some examples of the method, second UEs, and non-transitory computer-readable medium described herein may further include operations, features, means, or instructions for receiving, from the first UE, a broadcast message that includes a set of positioning parameters associated with the first UE and a CAA-level ID that identifies the first UE, where the one or more proximity parameters associated with the first UE include an application-layer ID that may be unique to the first UE, the application-layer ID associated with a service type and derived from the CAA-level ID included in the broadcast message and determining the metric including a distance between the first UE and the second UE based on the set of positioning parameters and the one or more proximity parameters, where the threshold includes a distance threshold.

In some examples of the method, second UEs, and non-transitory computer-readable medium described herein, the UE-specific ID includes a CAA-level ID that identifies the second UE.

In some examples of the method, second UEs, and non-transitory computer-readable medium described herein, the DCR message excludes an application-layer ID associated with the service type.

In some examples of the method, second UEs, and non-transitory computer-readable medium described herein, the broadcast message includes a set of proximity parameters associated with the second UE.

In some examples of the method, second UEs, and non-transitory computer-readable medium described herein, at least one unicast message of the unicast messages includes a unicast DAA message.

A method for wireless communication by a first UE is described. The method may include establishing a communication link with a second UE according to a service type, communicating, with the second UE, a sidelink message indicating one or more parameters for communication of unicast DAA messages, and communicating, with the second UE, one or more unicast DAA messages according to the one or more parameters.

A first UE for wireless communication is described. The first UE may include one or more memories storing processor executable code, and one or more processors coupled with the one or more memories. The one or more processors may individually or collectively operable to execute the code to cause the first UE to establish a communication link with a second UE according to a service type, communicating, with the second UE, a sidelink message indicate one or more parameters for communication of unicast DAA messages, and communicating, with the second UE, one or more unicast DAA messages accord to the one or more parameters.

Another first UE for wireless communication is described. The first UE may include means for establishing a communication link with a second UE according to a service type, means for communicating, with the second UE, a sidelink message indicating one or more parameters for communication of unicast DAA messages, and means for communicating, with the second UE, one or more unicast DAA messages according to the one or more parameters.

A non-transitory computer-readable medium storing code for wireless communication is described. The code may include instructions executable by a processor to establish a communication link with a second UE according to a service type, communicating, with the second UE, a sidelink message indicate one or more parameters for communication of unicast DAA messages, and communicating, with the second UE, one or more unicast DAA messages accord to the one or more parameters.

In some examples of the method, first UEs, and non-transitory computer-readable medium described herein, the service type includes an A2X service type.

In some examples of the method, first UEs, and non-transitory computer-readable medium described herein, communicating the sidelink message may include operations, features, means, or instructions for receiving the UAI sidelink message from the second UE and determining the one or more parameters for the communication of unicast DAA messages based on the one or more positioning parameters associated with the second UE.

In some examples of the method, first UEs, and non-transitory computer-readable medium described herein, communicating the sidelink message may include operations, features, means, or instructions for receiving the UAI sidelink message from the second UE.

In some examples of the method, first UEs, and non-transitory computer-readable medium described herein, communicating the one or more unicast DAA messages may include operations, features, means, or instructions for receiving the one or more unicast DAA messages from the second UE.

In some examples of the method, first UEs, and non-transitory computer-readable medium described herein, communicating the sidelink message may include operations, features, means, or instructions for transmitting the sidelink message to the second UE.

In some examples of the method, first UEs, and non-transitory computer-readable medium described herein, communicating the one or more unicast DAA messages may include operations, features, means, or instructions for receiving the one or more unicast DAA messages from the second UE.

In some examples of the method, first UEs, and non-transitory computer-readable medium described herein, communicating the one or more unicast DAA messages may include operations, features, means, or instructions for transmitting, to the second UE, a request for a unicast DAA message of the one or more unicast DAA messages and receiving the unicast DAA message from the second UE based on the request.

In some examples of the method, first UEs, and non-transitory computer-readable medium described herein, communicating the one or more unicast DAA messages may include operations, features, means, or instructions for transmitting, to the second UE, one or more positioning reference signals (PRSs) and receiving the one or more unicast DAA messages from the second UE based on the one or more PRSs.

Some examples of the method, first UEs, and non-transitory computer-readable medium described herein may further include operations, features, means, or instructions for transmitting, to the second UE, a first control message indicating a set of configurations for the service type and transmitting, to the second UE, a second control message indicating that a configuration from the set of configurations may be activated, the configuration including the one or more parameters.

In some examples of the method, first UEs, and non-transitory computer-readable medium described herein, the first control message includes a radio resource control (RRC) message and the second control message includes a media access control (MAC) control element (MAC-CE) message or a sidelink control information (SCI) message.

In some examples of the method, first UEs, and non-transitory computer-readable medium described herein, communicating the sidelink message may include operations, features, means, or instructions for transmitting the UAI sidelink message to the second UE.

In some examples of the method, first UEs, and non-transitory computer-readable medium described herein, communicating the sidelink message may include operations, features, means, or instructions for transmitting the UAI sidelink message to the second UE.

In some examples of the method, first UEs, and non-transitory computer-readable medium described herein, communicating the one or more unicast DAA messages may include operations, features, means, or instructions for transmitting the one or more unicast DAA messages to the second UE.

In some examples of the method, first UEs, and non-transitory computer-readable medium described herein, communicating the sidelink message may include operations, features, means, or instructions for receiving the sidelink message from the second UE.

In some examples of the method, first UEs, and non-transitory computer-readable medium described herein, communicating the one or more unicast DAA messages may include operations, features, means, or instructions for transmitting the one or more unicast DAA messages to the second UE.

In some examples of the method, first UEs, and non-transitory computer-readable medium described herein, communicating the one or more unicast DAA messages may include operations, features, means, or instructions for receiving, from the second UE, a request for a unicast DAA message of the one or more unicast DAA messages and transmitting the unicast DAA message to the second UE based on the request.

In some examples of the method, first UEs, and non-transitory computer-readable medium described herein, communicating the one or more unicast DAA messages may include operations, features, means, or instructions for receiving, from the second UE, one or more positioning reference signals (PRSs) and transmitting the one or more unicast DAA messages to the second UE, the one or more unicast DAA messages including positioning information associated with the first UE based on receiving the one or more PRSs.

Some examples of the method, first UEs, and non-transitory computer-readable medium described herein may further include operations, features, means, or instructions for receiving a first control message indicating a set of configurations for the service type and receiving a second control message indicating that a configuration from the set of configurations may be activated, the configuration including the one or more parameters.

In some examples of the method, first UEs, and non-transitory computer-readable medium described herein, the first control message includes an RRC message and the second control message includes a MAC-CE message or an SCI message.

### BRIEF DESCRIPTION OF THE DRAWINGS

FIG. 1 shows an example of a wireless communications system that supports unicast A2X communications in accordance with one or more aspects of the present disclosure.

FIG. 2 shows an example of a wireless communications system that supports unicast A2X communications in accordance with one or more aspects of the present disclosure.

FIGS. 3-5 show examples of process flows that support unicast A2X communications in accordance with one or more aspects of the present disclosure.

FIGS. 6 and 7 show block diagrams of devices that support unicast A2X communications in accordance with one or more aspects of the present disclosure.

FIG. 8 shows a block diagram of a communications manager that supports unicast A2X communications in accordance with one or more aspects of the present disclosure.

FIG. 9 shows a diagram of a system including a device that supports unicast A2X communications in accordance with one or more aspects of the present disclosure.

FIGS. 10 through 17 show flowcharts illustrating methods that support unicast A2X communications in accordance with one or more aspects of the present disclosure.

### DETAILED DESCRIPTION

A wireless communications system may support communications between terrestrial wireless devices (e.g., user equipments (UEs), network entities) and aerial vehicles such as unmanned aerial vehicles (UAVs) or other unmanned aerial systems (UASs). Such UAVs may access or otherwise benefit from UAV-related services and communications (which may be referred to as air-to-everything (A2X) services and communications, UAV-to-everything (U2X) services and communications, or the like). For example, the wireless communications system may support UAV-to-UAV communications and UAV-to-terrestrial UE communications. Some types of UAV-to-UAV communications may include broadcast messages, such as broadcast remote identifier (BRID) messages that indicate information regarding the position and heading of a UAV, flight information for remote identification, a unique UAV identifier specific to the UAV (e.g., a civil aviation administration (CAA) level identity), or the like, among other examples. Additionally, UAV-to-UAV communications may include broadcast and/or unicast detect and avoid (DAA) messages, intended to assist UAVs in avoiding collisions with each other. Such DAA messages may be similar to safety messages used in vehicle-to-everything (V2X) communications as the UAVs may broadcast information about their position, headings, and other location information. Although V2X and A2X operations may share some similarities, some procedures and parameters for V2X communications and services may be different from or inapplicable to A2X services and communications, and separate A2X procedures and parameters may need to be defined.

Accordingly, aspects of the present disclosure are directed to techniques that enable unicast link establishment for A2X communications between two UEs (e.g., UAVs). In particular, aspects of the present disclosure support signaling used to initiate a unicast link establishment procedure between two UEs, techniques for performing the unicast link establishment procedure, and configurations and parameters for communicating via the unicast link according to an A2X service. For example, a first UE receiving a broadcast DAA may detect a potential collision with a second UE broadcasting the DAA. The first UE may be triggered to initiate a unicast link establishment procedure and, as such, may transmit a direct communication request (DCR) message to the second UE. The DCR message may include a unique identifier (ID) for the second UE to indicate that the DCR message is intended for the second UE. In some cases, the unique ID may be an application-layer ID that the first UE derives from the UAV ID for the second UE included in the broadcast DAA. Based on receiving the DCR message, the second UE may respond with a link establishment message transmitted to the first UE, and the first UE and the second UE may subsequently communicate unicast messages via the established unicast link.

In some examples, the first UE and the second UE may communicate via the unicast link according to one or more communication parameters (e.g., one or more parameters for communicating unicast DAA messages). For instance, the first UE may determine the one or more communication parameters and may indicate the one or more communication parameters to the second UE, e.g., via a sidelink message. Additionally, or alternatively, the second UE may transmit a UE assistance information (UAI) message to the first UE indicating a set of preferred communication parameters, and the first UE may determine the one or more communication parameters based on the UAI message. In some examples, the first UE, the second UE, or both may be configured (e.g., via control signaling, such as a radio resource control (RRC) message) with a set of configurations for communicating unicast DAA messages, and may receive a control message (e.g., a media access control (MAC) control element (MAC-CE), sidelink control information (SCI)) indicating that a configuration of the set of configurations is activated. The first UE and the second UE may communicate according to one or more communication parameters associated with the activated configuration.

Aspects of the disclosure are initially described in the context of wireless communications systems. Aspects of the disclosure are then discussed with reference to process flows. Aspects of the disclosure are further illustrated by and described with reference to apparatus diagrams, system diagrams, and flowcharts that relate to unicast A2X communications.

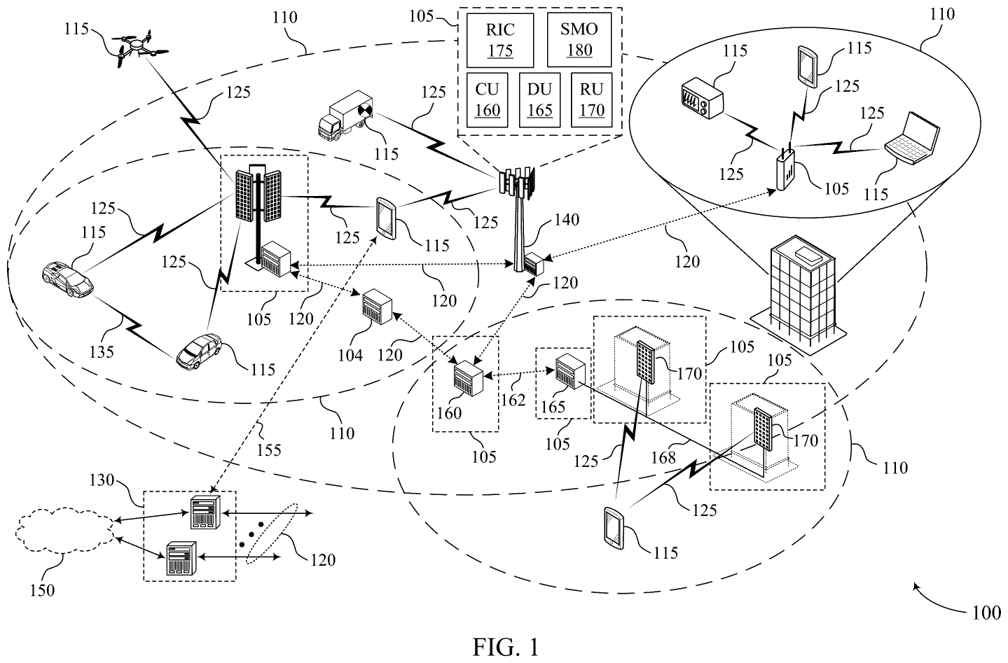

FIG. 1 shows an example of a wireless communications system 100 that supports unicast A2X communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-NB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support unicast A2X communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support communications between terrestrial wireless devices (e.g., UEs 115, network entities 105) and aerial vehicles such as UAV UEs 115 or other unmanned aerial systems. For example, the wireless communications system may support UAV-to-UAV communications (between UAV UEs 115 via a communication link 125) and UAV-to-terrestrial UE or network entity communications. Some types of UAV-to-UAV communications may be referred to as A2X services and communications, such as DAA messages that are intended to assist UAV UEs 115 in avoiding collisions with each other. Such DAA messages may broadcast information about a UAV's position, headings, and other location information. A UAV UE 115 may broadcast a DAA message and any UAV UEs 115 may be able to receive the DAA message and determine, based on location information in the DAA message, whether there is risk of a collision with the broadcasting UAV UE 115. Additionally, A2X services may include broadcast BRID messages that may include a unique, UE-specific ID associated with the transmitting UAV UE 115. In some cases, BRID messages may also indicate information regarding the position and heading of a UAV UE 115 and flight information for remote identification. In some examples, a terrestrial UE 115 may be associated with a user on the ground.

Additionally, the wireless communications system 100 may support unicast link establishment for A2X communications between two UAV UEs 115 in accordance with the techniques described herein. A first UE 115 (e.g., a UAV UE) may broadcast a DAA message indicating its location information and, in some cases, a UE-specific ID unique to the first UE 115, such as a CAA-level ID. A second UE 115 (e.g., a UAV UE) may receive the broadcast DAA message and determine, based on the location information, whether a collision with the first UE 115 is possible or imminent. For example, an application layer of the second UE 115 may compare its trajectory (e.g., a trajectory of the second UE 115) with the location information of the first UE 115. If the application layer of the second UE 115 detects a possible collision situation, the application layer may initiate a collision avoidance or conflict resolution procedure with the first UE 115. In some examples, the second UE 115 may inform an unmanned aircraft service supplier (USS) of the detected potential collision.

As part of the collision avoidance or conflict resolution procedure, the second UE 115 may select a communication mode (e.g., broadcast or unicast) for DAA deconfliction, e.g., based on any associated A2X policies and input received from the application layer. If the second UE 115 selects a broadcast communication mode, the second UE 115 may broadcast a DAA message that includes a request to exchange information used for deconfliction. The first UE 115 may receive the DAA message and may respond by broadcasting a second DAA message that includes a deconfliction response. In other scenarios, the second UE 115 may instead select a unicast communication mode and may trigger (e.g., initiate) a UE-oriented layer-2 link establishment procedure for unicast communication with the first UE 115.

For instance, as described herein, triggering the layer-2 link establishment procedure may include the second UE 115 transmitting a DCR message to the first UE 115, where the DCR message includes a request to exchange the information used for deconfliction, a request to establish a unicast link with the first UE 115, or a combination thereof. Additionally, the DCR message may include target user info associated with a target of the DCR message (e.g., the first UE 115), such as a unique, UE-specific ID associated with the first UE 115 to indicate that the DCR message is intended for the first UE 115. In some cases, the unique ID may be an application-layer ID associated with the first UE 115 that the second UE 115 derives from the CAA-level ID associated with the first UE 115 (e.g., as indicated in the broadcast DAA). For example, the second UE 115 may derive the application-layer ID associated with the first UE 115 based on a one-to-one mapping between the CAA-level ID and the application-layer ID indicated in the DCR message.

Alternatively, the DCR message may exclude target user info and may instead include location information associated with the second UE 115. Without explicit target user info, the DCR message transmitted from the second UE 115 may be responded to by one or multiple other UEs 115. In some cases, the DCR message may explicitly indicate the location information, such as a position, velocity, and direction (e.g., heading direction) associated with the second UE 115. The first UE 115 may use the location information to determine whether to respond to the DCR message and, in doing so, proceed with the unicast link establishment procedure.

In other cases, the DCR message may include information to assist the first UE 115 in determining location information associated with the second UE 115. For instance, the DCR message may include an indication of a transmit power of the DCR message (e.g., of a reference signal, such as a demodulation reference signal (DMRS), in the DCR message), an energy per resource element (EPRE) of the DCR message (e.g., of a reference signal, such as a DMRS, in the DCR message), or the like, among other examples. Here, the first UE 115 may measure a reference signal received power (RSRP) of the received DCR message and may use the RSRP and the transmit power or EPRE to calculate a path loss associated with the DCR message. Based on the path loss, the first UE 115 may determine whether to respond to the DCR message and proceed with the unicast link establishment procedure.

In another example, when the DCR message excludes target user information, the second UE 115 may instead include a unique, UE-specific ID (e.g., an application-layer ID associated with the A2X service type) corresponding to the second UE 115 in the DCR message. The second UE 115 may periodically transmit broadcast DAA messages that include positioning information and a CAA-level ID that is unique to the second UE 115. The second UE 115 may derive the UE-specific ID to indicate in the DCR message from the CAA-level ID used for the broadcast DAA messages. The first UE 115 may receive the broadcast DAA message(s) and the DCR message from the second UE 115. The first UE 115 may use the UE-specific ID of the second UE 115 from the DCR message, and the positioning information of the second UE 115 from the broadcast DAA message(s), to determine a proximity of the second UE 115 to the first UE 115. Based on the proximity (e.g., based on a distance between the second UE 115 and the first UE 115), the first UE 115 may determine whether to respond to the DCR message.

If the first UE 115 determines to respond to the DCR, the first UE 115 may transmit a link establishment message to the second UE 115, and the first UE 115 and the second UE 115 may subsequently communicate unicast messages via the established unicast link. In some examples, the first UE 115 and the second UE 115 may communicate via the unicast link according to one or more communication parameters (e.g., one or more parameters for communicating unicast DAA messages). For instance, the first UE 115 may determine the one or more communication parameters and may indicate the one or more communication parameters to the second UE 115, e.g., via a sidelink message. Additionally, or alternatively, the second UE 115 may transmit a UAI message to the first UE 115 indicating a set of preferred communication parameters, and the first UE 115 may determine the one or more communication parameters based on the UAI message. In some examples, the first UE 115, the second UE 115, or both may be configured (e.g., via control signaling, such as an RRC message) with a set of configurations for communicating unicast DAA messages, and may receive a control message (e.g., a MAC-CE, SCI) indicating that a configuration of the set of configurations is activated. The first UE 115 and the second UE 115 may communicate via the unicast link according to one or more communication parameters associated with the activated configuration.

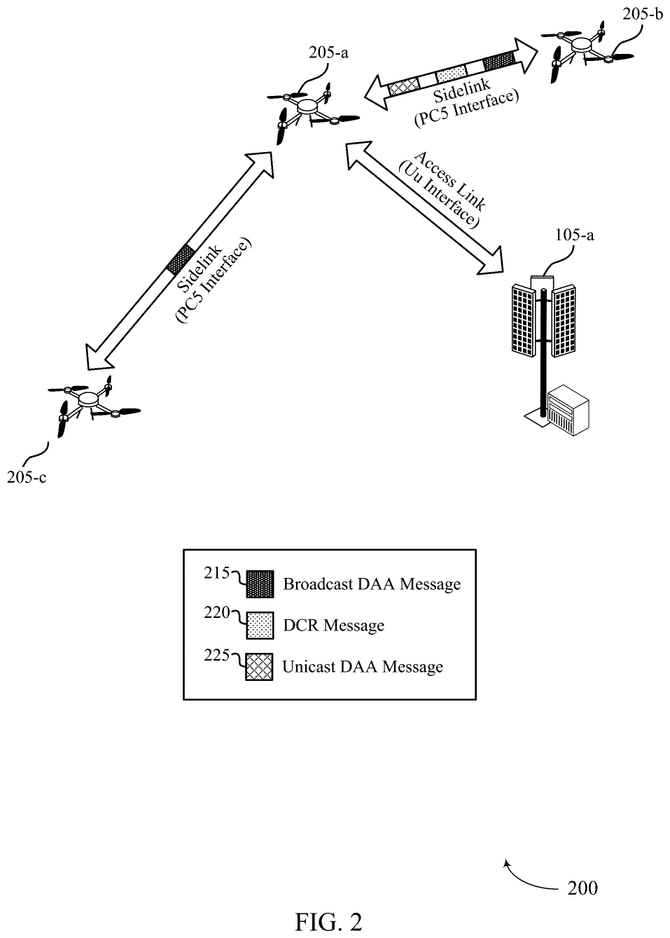

FIG. 2 shows an example of a wireless communications system 200 that supports unicast A2X communications in accordance with one or more aspects of the present disclosure. The wireless communications system 200 includes a UAV 205-a, a UAV 205-b, a UAV 205-c, and a network entity 105-a. The network entity 105-a may be a terrestrial wireless device that operates on the ground. The UAVs 205 may be examples of aerial UEs (e.g., UAV UEs) that operate in an autonomous flying mode. For example, the UAVs 205 may be aircraft, drones, remote piloted aircrafts, piloted aircrafts, or the like.

The wireless communications system 200 may support communications between the network entity 105-a and the UAVs 205 via respective communication links, which may be examples of communication links 125 described herein with reference to FIG. 1. For example, the UAVs 205 and the network entity 105-a may perform uplink and downlink communications via a Uu link (e.g., a bi-directional link that enables both uplink and downlink communication), and UAVs 205 may communicate with one another via one or more PC5 links (e.g., sidelink communication links). In this way, the wireless communications system 200 may support UAV-to-UAV communications and UAV-to-terrestrial UE communications.

The UAVs 205 may operate as part of an unmanned aircraft systems (UAS) traffic management (UTM) system and may support A2X services and communications. An A2X application may include any application using one or more A2X services. In general, the term “A2X communication” may refer to communication to support A2X services leveraging Uu and/or PC5 reference points. An A2X service belongs to one A2X service type, and may include a message or other data delivery. An A2X service can be associated with one or more A2X applications, and an A2X application can be associated with one or more A2X services. One example of an A2X service may include DAA, in which a UAV 205 may surveil traffic and remain a safe distance from nearby aircraft (e.g., cooperative aircraft and non-cooperative aircraft) so as not to create a collision hazard.

For example, the UAVs 205 may transmit and receive A2X services (e.g., BRID, DAA, UAV-to-UAV communications, UAV-to-terrestrial communications) via the PC5 links. Some types of A2X communications may include DAA messages, intended to assist the UAVs 205 in avoiding collisions with each other. Such DAA messages may broadcast information about a UAV's position, headings, and other location information. DAA messages may provide situational awareness, alerting, and avoidance used to maintain safe beyond visual line of sight (BVLOS) operation of the UAVs 205. In addition, different variants or types of the DAA messages may correspond to different requirements of the UAVs 205. For example, a broadcast DAA may include an application layer DAA payload that indicates a CAA-level UAV ID associated with the transmitting UAV 205, a location, a heading, a time, and other information (e.g., location and direction information), and may be broadcast periodically by a UAV 205. A DAA deconfliction message may be broadcast or unicast and may indicate data different from (or additional to) the information indicated in the broadcast DAA message.

To support DAA signaling, the UAVs 205 may be implemented with DAA systems (or sense and avoid (SAA) systems) which may allow UAVs 205 to integrate into civilian airspace by avoiding collisions with other aircrafts or UAVs, buildings, power lines, birds, and other obstacles. These systems are configured to observe an environment surrounding the UAV 205, determine whether a collision is imminent, and generate a new flight path in order to avoid a collision. UAV DAA/SAA systems may combine data from a number of sensors, using sensor fusion algorithms, image recognition, and artificial intelligence to support collision avoidance. Data may be fed back to the UAV on-board computer and/or UAV flight controller, which can then decide on an evasive maneuver or flight path correction to avoid collision.

Some DAA solutions may be active or passive solutions that use sensor data. Passive solutions may use electro-optical data (e.g., cameras), passive radar, and/or acoustic data. Active solutions may use sonar, lidar, and/or active radar. Some solutions may also be communications based. For example, the UAVs 205 may use systems designed for manned aviation, such as traffic collision and avoidance systems (TCAS) and/or automatic dependent surveillance-broadcast (ADS-B) systems that periodically broadcast and receive identity data, position data, and other information. Some standards may define DAA requirements based on airborne collision avoidance systems (ACAS).

Some types of A2X services may include BRID messages that may indicate a UAS ID, UA type, UAS ID type, position and heading information of a UAV 205, and flight information for remote identification. A BRID message may indicate an identifier of the transmitting UAV 205 (e.g., a CAA-level UAV ID, a UAS ID, or the like), a UAS ID type, or an unmanned aircraft (UA) type, among other examples. For example, the UAS ID may indicate a serial number (e.g., expressed in a CTA-2063-A serial number format), a registration ID such as a CAA-level ID (e.g., if a Civil Aviation Authority (CAA) provides a method of registering the UAS, the number is provided by the CAA or an authorized representative), and a UTM ID (e.g., a universal unique ID (UUID)), which may be a UTM-provided unique ID traceable to the registration ID that may act as a session ID to protect exposure of operationally sensitive information. The UAS ID type may indicate the serial number, the registration ID, or the UTM UUID. The UA type may help in inferring performance, speed, and duration of UAV flights (e.g., a fixed wing aircraft may generally fly in a forward direction as compared to a multi-rotor aircraft), differentiate aircraft types without sharing operationally sensitive information, and correlate visual observations with received data.

In order to support PC5-based A2X communication as illustrated in the example of FIG. 2, the UAVs 205 may be configured with policy and parameters (e.g., RAT type, RF parameters, QoS requirements, serving PLMN) to perform PC5 communication with other devices (e.g., other UAVs, other UEs). Some A2X services and procedures may rely on or be associated with V2X services and procedures. In some cases, however, some parameters and procedures for V2X may not apply to A2X services due to the different requirements of the service types, applications, policy and QoS requirements, and radio parameters. In this regard, conventional V2X techniques may not be suitable for A2X policy and parameters for the UAVs 205.

For instance, a V2X procedure for establishing a unicast communication link between UEs (e.g., a layer-2 link establishment procedure) may not directly translate to A2X services and communications. As an example, a UE operating according to a V2X service type may initiate a unicast link establishment procedure with a target UE by transmitting a DCR that includes an indication of the V2X service type and an application-layer ID of the target UE, but A2X services may have a defined A2X service type, different from that of V2X. In V2X, the application-layer ID may be an ID for a vehicle, a pedestrian, an RSU (e.g., within the context of a V2X application), or the like, may not be able to be used for UEs that support A2X services (e.g., BRID, DAA). For example, an application-layer ID associated with A2X services may be directly derived from the payload of A2X services. In another example, A2X services may be associated with A2X-specific PC5 QoS identifiers (PQIs) that are not interchangeable with V2X PQIs. Additionally, or alternatively, some A2X services and procedures may not have sufficiently-defined parameters or configurations for optimal performance. Accordingly, the techniques described herein support A2X services and communications that are based on conventional V2X techniques, but have been adjusted to be applicable to A2X devices and scenarios.

The UAV 205-a may transmit a broadcast DAA message 215 to other UAVs 205 according to a broadcast communication mode. In some cases, the UAV 205-a may periodically broadcast DAA messages, e.g., according to a periodicity. The broadcast DAA message 215 may indicate A2X service information, such as an A2X service type, an A2X service ID, or the like, that identifies the A2X service associated with the broadcast DAA message 215. The broadcast DAA message 215 may further include an application layer DAA payload, which may indicate a unique, UE-specific ID for the UAV 205-a, such as a CAA-level UAV ID of the UAV 205-a. The application layer DAA payload may further indicate position information of the UAV 205-a, such as a velocity, position, heading direction, or the like. A UE receiving the broadcast DAA message 215 may determine whether to decode or respond to the broadcast DAA message 215 based on the indicated A2X service type. For instance, a terrestrial-based UE may refrain from responding to the broadcast DAA message 215, as the terrestrial-based UE may not wish to participate in the indicated A2X service.

A UAV 205, however, such as the UAV 205-b, the UAV 205-c, or both, may receive the broadcast DAA message 215 (e.g., based on the indicated A2X service) and may pass the application layer DAA payload to an upper layer of the UAV 205, such as an application layer. The application layer of the UAV 205 may perform collision detection to determine whether a potential collision with the UAV 205-a may occur. In some examples, the collision detection may include comparing the position information of the UAV 205-a with a trajectory, location, position, or some combination thereof, of the UAV 205. For instance, the UAV 205 may determine a metric (e.g., a collision detection metric) based on the trajectory and position of the UAV 205-a and the trajectory and position of the UAV 205, where a collision or potential collision scenario may be detected if the metric satisfies a threshold.

In the example of FIG. 2, the UAV 205-c may be sufficiently far from the UAV 205-a such that the UAV 205-c does not detect a possible collision with the UAV 205-a. The UAV 205-b may be relatively closer to the UAV 205-a or may have a trajectory or position that conflicts with the trajectory or position of the UAV 205-a, and as such, the UAV 205-b may detect a potential collision scenario with the UAV 205-a. As a result, the UAV 205-b may initiate a collision avoidance or conflict resolution procedure with the UAV 205-a. As part of the collision avoidance or conflict resolution procedure, the UAV 205-b may select a unicast communication mode for DAA deconfliction, e.g., based on any associated A2X policies and input received from the application layer. The UAV 205-b may trigger (e.g., initiate) a unicast (e.g., layer 2) link establishment procedure for unicast communication with the UAV 205-a, in which the UAV 205-b may be understood or referred to as a source device (e.g., a source UE) and the UAV 205-a may be understood or referred to as a target device (e.g., a target UE). During the unicast link establishment procedure, the UAV 205-b may determine a destination layer 2 ID for signaling reception for PC5 unicast link establishment, where the destination layer 2 ID may be understood as an ID of a target device (e.g., the UAV 205-a) with which the UAV 205-b wishes to establish the unicast link.

The application layer of the UAV 205-b may provide application information for PC5 unicast communication. The application information may include the A2X service type(s) and, in some cases, the UE-specific ID associated with the UAV 205-a. In some examples, the application layer may additionally provide any A2X application requirements for unicast communication, and the UAV 205-b may determine the associated PC5 QoS parameters and PC5 QoS flow ID (PFI). The UAV 205-b may transmit a DCR message 220 to the UAV 205-a as part of the unicast link establishment procedure. The DCR message 220 may include an indication of a request to establish the unicast link with the UAV 205-a. In some cases, the DCR message 220 may further include information about the source device (e.g., the UAV 205-b), such as a unique, UE-specific ID associated with the UAV 205-b (e.g., a CAA-level ID, an application-layer ID), and may include information relating to the A2X service type(s) requesting link establishment, security information for establishing security with the UAV 205-a, or any combination thereof.

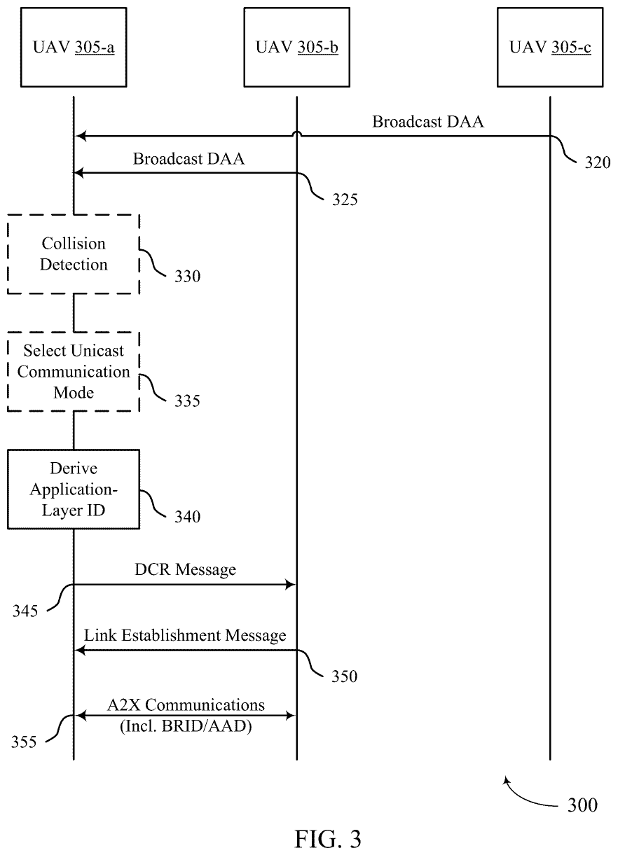

The techniques described herein support schemes for A2X unicast link establishment for an A2X unicast link used to communicate DAA messages between UAVs, e.g., based on collision detection. In a first scheme, and as described with reference to FIG. 3, the DCR message 220 may further include information about the target device (e.g., the UAV 205-a), such as an application-layer ID used for A2X unicast communications associated with the UAV 205-a. Here, the source device (e.g., the UAV 205-b) may derive or otherwise obtain the application-layer ID for the UAV 205-a based on the unique, UE-specific ID associated with the UAV 205-a (e.g., as indicated in the DAA payload of the broadcast DAA message 215). For example, the UAV 205-b may derive the application-layer ID for the UAV 205-a using a one-to-one mapping from the UE-specific ID of the UAV 205-a to the application-layer ID of the UAV 205-a. In some cases, the application layer of the UAV 205-b may derive or otherwise obtain the application-layer ID of the UAV 205-a and may provide the application-layer ID to the UAV 205-b. The DCR message 220 may include an implicit or explicit indication of the application-layer ID of the UAV 205-a.

In some examples, the UAV 205-b may derive the UE-specific ID of the UAV 205-a based on the CAA-level ID of the UAV 205-a (e.g., when the broadcast DAA message 215 indicates the CAA-level ID of the UAV 205-a). Here, the UAV 205-b may then determine the application-layer ID of the UAV 205-a based on the mapping between the UE-specific ID and the application-layer ID. Alternatively, the UE-specific ID may include or be an example of the CAA-level ID of the UAV 205-a, such that the UAV 205-b derives the application-layer ID from the CAA-level ID of the UAV 205-a. In some examples, the CAA-level ID of the UAV 205-a may be directly used (e.g., and indicated) as the application-layer ID of the UAV 205-a. Alternatively the application-layer ID for the UAV 205-a may be derived from the UE-specific ID of the UAV 205-a according to a function (e.g., a hash function, truncating, padding).

Due to the nature of A2X communications and devices, an A2X communication channel may be a LOS channel, such that an A2X signal (e.g., a broadcast DAA message 215, a DCR message 220) may reach UAVs that are relatively far away from a transmitting UAV. However, unicast DAA messages (e.g., unicast DAA messages 225) and collision detection procedures may only be useful for UAVs that are relatively near one another and are at risk of collision. Accordingly, a source device, a target device, or both may choose whether to respond to an A2X message (e.g., a broadcast DAA message 215, a DCR message 220) based on a proximity.

In the first scheme, the source device (e.g., the device transmitting a DCR message 220, such as the UAV 205-b) may determine whether to respond to an A2X message. For instance, the UAV 205-b may receive multiple broadcast DAA messages 215 from multiple UAVs 205, such as the UAV 205-a and the UAV 205-c. Each broadcast DAA message 215 may include a respective UE-specific ID and a respective one or more positioning parameters associated with the respective UAV 205. The one or more positioning parameters may be indicative of a location and trajectory of the respective UAV 205, such as a position, velocity, and heading direction. The UAV 205-b may select or otherwise determine a broadcast DAA message 215 to which to respond with a DCR message 220 based on the one or more positioning parameters. For example, the UAV 205-b may select a target device (e.g., a UAV 205) with which to establish an A2X unicast communication link for collision avoidance (e.g., for communication of unicast DAA messages 225) based on a distance between the UAV 205-b and the target device.

The UAV 205-b may determine the distance between itself and the UAV 205-a using the one or more positioning parameters indicated in the broadcast DAA message 215 received from the UAV 205-a, and may determine the distance between itself and the UAV 205-c using the one or more positioning parameters indicated in the broadcast DAA message 215 received from the UAV 205-c. The UAV 205-b may determine that the UAV 205-a is closer than the UAV 205-c, and as such, may select the UAV 205-a as the target device and transmit the DCR message 220. In some cases, the UAV 205-b may compare the distance to a threshold distance, where the UAV 205-b transmits the DCR message 220 to the target device if the distance satisfies (e.g., is less than) the threshold distance. Additionally, or alternatively, the UAV 205-b may determine a metric based on the distance and a trajectory of the UAV 205-b, and may transmit the DCR message 220 to the target device if the metric satisfies a threshold (e.g., a distance threshold).

In any case, the UAV 205-b may include the UE-specific ID of the selected target device, such as the UAV 205-a, in the DCR message 220. The UAV 205-a may respond to the DCR message 220 by establishing security with the UAV 205-b based on the information included in the DCR message 220, such as the UE-specific ID. The UAV 205-a and the UAV 205-b may subsequently communicate one or more unicast DAA messages 225 via the established unicast communication link.

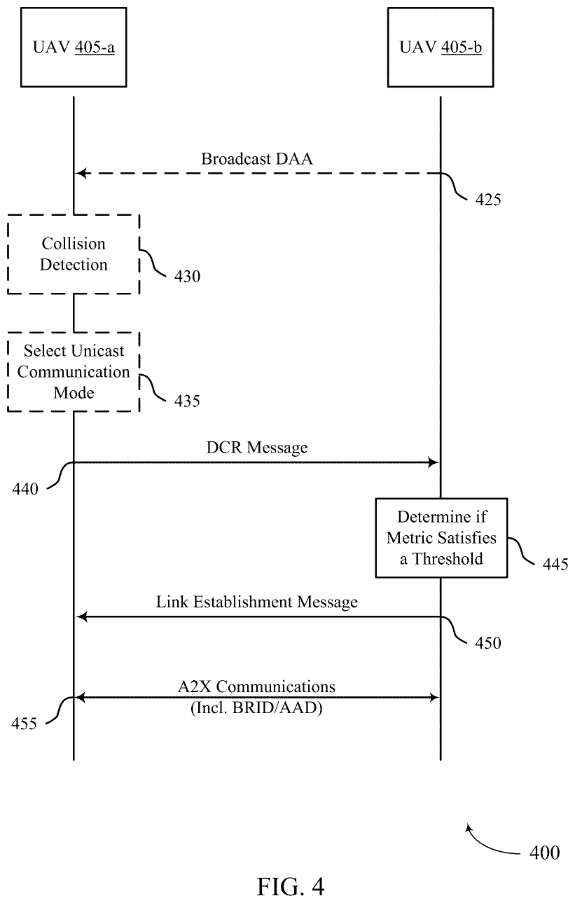

In the second scheme, and as described with reference to FIG. 4, the UAV 205-b may exclude target device information from the DCR message 220. Here, the DCR message 220 may include an indication of the A2X service type(s) (e.g., DAA messages) and any device (e.g., any UAV 205) interested in using the indicated A2X service type(s) over a unicast link may respond to the DCR message 220 and establish the unicast link with the UAV 205-b. To prevent responses from UAVs 205 that are relatively far from the UAV 205-b, the UAV 205-b may include, in the DCR message 220, an indication of one or more proximity parameters (e.g., one or more parameters based on which a proximity to the UAV 205-b may be derived). Thus, in the second scheme, a target device (e.g., a device receiving the DCR message 220, such as the UAV 205-a) may determine whether to respond to the DCR message 220 based on the one or more proximity parameters.

For example, the UAV 205-a may determine whether the UAV 205-b is relatively close in proximity to the UAV 205-a based on the one or more proximity parameters. In some cases, the one or more proximity parameters may include information indicative of a position or location of the UAV 205-b, such as a position, velocity, and heading direction, and the UAV 205-a may determine whether a distance between the UAV 205-a and the UAV 205-b satisfies (e.g., is less than) a distance threshold. The UAV 205-a may, for example, determine a metric using the one or more proximity parameters and a trajectory of the UAV 205-a and may compare the metric to the distance threshold. If the metric satisfies the distance threshold, the UAV 205-a may respond to the DCR message 220 by establishing security with the UAV 205-b and subsequently communicating unicast messages (e.g., unicast DAA messages 225) via the established unicast link.

In other cases, the one or more proximity parameters may include information that enables the UAV 205-a to discern a path loss associated with the DCR message 220, such as a transmit power of the DCR message 220, an EPRE of a reference signal (e.g., a DMRS, such as a physical sidelink shared channel (PSSCH) DMRS)) included in the DCR message 220, or a combination thereof, among other examples. The UAV 205-a may measure an RSRP of the DCR message 220 and may calculate a path loss associated with the DCR message 220 based on the one or more proximity parameters and the RSRP. In this example, the threshold may be a path loss threshold, and the UAV 205-a may compare the calculated path loss to the path loss threshold. Additionally, or alternatively, the UAV 205-a may determine the metric using the path loss and the trajectory of the UAV 205-a and may compare the metric to the path loss threshold. In either case, if the path loss threshold is satisfied, the UAV 205-a may respond to the DCR message 220 by establishing security with the UAV 205-b and subsequently communicating unicast messages (e.g., unicast DAA messages 225) via the established unicast link.

In another example, the one or more proximity parameters may include a unique, UE-specific ID associated with the UE 115-b, such as an application-layer ID associated with the A2X service type. The UE 115-b may transmit one or more broadcast DAA messages 215 that include positioning information associated with the UE 115-b and a CAA-level ID that is unique to the UE 115-b. The UE 115-b may derive the application-layer ID from the CAA-level ID of the UE 115-b used for the broadcast DAA message(s) 215. The UE 115-a may receive the broadcast DAA message(s) 215 and the DCR message 220 from the second UE 115-b. The UE 115-a may determine a location or position of the UE 115-b based on the application-layer ID of the UE 115-b and the positioning information from the broadcast DAA message(s). For example, the UE 115-a may identify (e.g., based on a mapping) that the application-layer ID of the UE 115-b indicated in the DCR message 220 corresponds to the CAA-level ID indicated in a broadcast DAA message 215 transmitted by the UE 115-b. Accordingly, the UE 115-a may use the positioning information in the corresponding broadcast DAA message 215 to determine the location or position of the UE 115-b. For instance, the UE 115-a may determine a distance between the UE 115-a and the UE 115-b, a proximity of the UE 115-b to the UE 115-a, or the like. The UE 115-a may determine the metric based on the proximity or distance and the trajectory of the UE 115-a. If the metric satisfies a corresponding threshold (e.g., a proximity threshold, a distance threshold), the UE 115-a may respond to the DCR message 220 by establishing security with the UAV 205-b and subsequently communicating unicast messages (e.g., unicast DAA messages 225) via the established unicast link.

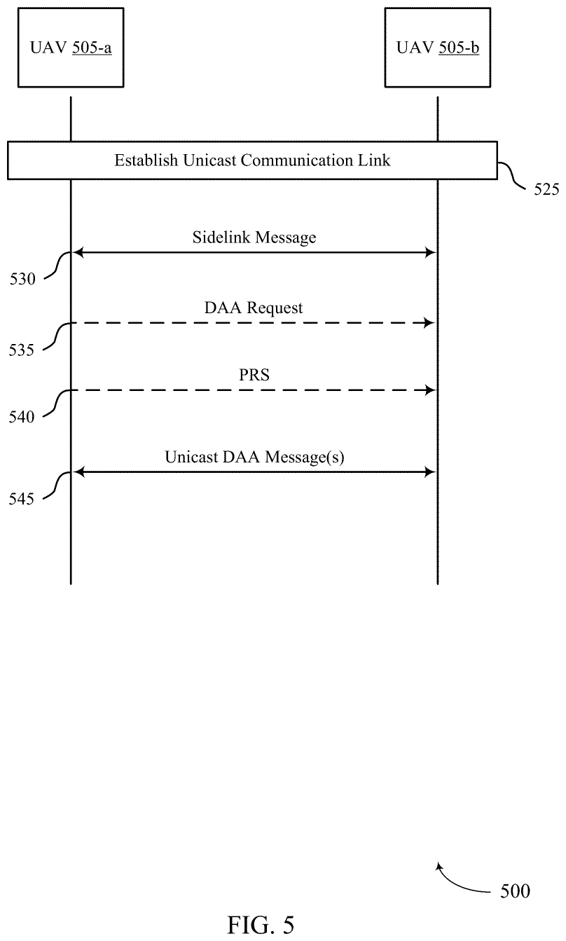

After the A2X unicast link is established between the UAV 205-a and the UAV 205-b, and as discussed with reference to FIG. 5, the UAVs 205 may communicate the unicast DAA message(s) 225 according to a unicast DAA message configuration that includes one or more parameters. The one or more parameters may include a periodicity for communicating the unicast DAA messages 225, power control information (e.g., a transmit power for transmission of the unicast DAA messages 225), or the like, among other examples. In some examples, the source device (e.g., the UAV 205-b) may configure the target device (e.g., the UAV 205-a) with the one or more parameters for communication of unicast DAA messages via the unicast link. For instance, the UAV 205-b may transmit a first control message, such as an RRC message (e.g., a sidelink RRC message), to the UAV 205-a that indicates a set of configurations, each configuration associated with a respective one or more parameters. The UAV 205-b may additionally transmit a second control message (e.g., a sidelink control message, such as a MAC-CE or SCI) to the UAV 205-a, where the second control message indicates that one configuration from the set of configurations is activated. Thus, the UAV 205-a and the UAV 205-b may communicate the unicast DAA messages 225 according to the one or more parameters corresponding to the activated configuration.

In another example, the source device (e.g., the UAV 205-b) may configure the target device (e.g., the UAV 205-a) with the one or more parameters based on sidelink UE assistance information (UAI) provided by the target device. The UAV 205-a may transmit a sidelink UAI message to the UAV 205-b that indicates a preferred configuration (e.g., a preferred value for each of the one or more parameters) for communicating unicast DAA messages. Additionally, or alternatively, the UAV 205-a may indicate, in the sidelink UAI message, position information (e.g., position, velocity, heading direction) of the UAV 205-a. Based on the sidelink UAI message, the UAV 205-b may select or otherwise determine the one or more parameters for communication of the unicast DAA messages 225. The UAV 205-b may indicate the one or more parameters to the UAV 205-a, e.g., via a sidelink message.

Additionally, or alternatively, the UAV 205-b may configure the UAV 205-a to measure and report positioning information associated with the UAV 205-a, e.g., as part of a unicast DAA message 225 or via a separate sidelink message. The UAV 205-b may indicate, to the UAV 205-a, one or more parameters for the report, such as a trigger event based on which the UAV 205-a is to transmit the report, a transmit power, a periodicity for transmitting the report, positioning information (such as a timing advance (TA)) to be included in the report, or a combination thereof. In some cases, the positioning information included in the report may be based on a global navigation satellite system (GNSS) or on one or more positioning reference signals (PRSs). In the latter example, the network entity 105-a or UAV 205-b may transmit the one or more PRSs to the UAV 205-a, and the UAV 205-a may determine the positioning information based on the one or more PRSs. In some examples, the UAV 205-b may request the report from the UAV 205-a, e.g., by transmitting a sidelink message indicating the request. The UAV 205-a may transmit the report to the UAV 205-b in response to the request.

FIG. 3 shows an example of a process flow 300 that supports unicast A2X communications in accordance with one or more aspects of the present disclosure. The process flow 300 may implement aspects of wireless communications systems 100 and 200, or may be implemented by aspects of the wireless communications system 100 and 200. For example, the process flow 300 illustrates operations between UAVs 305, which may be examples of corresponding devices (e.g., UEs, UAV UEs) described herein. The process flow 300 illustrates an example A2X unicast link establishment procedure that is based on a collision detection procedure for a UTM system.

In the following description of the process flow 300, the operations between the UAVs 305 may be transmitted in a different order than the example order shown, or the operations performed by the UAVs 305 may be performed in different orders or at different times. Some operations may also be omitted from the process flow 300, and other operations may be added to the process flow 300. Additionally, although the process flow 300 illustrates the UAVs 305, it is to be understood that any device or combination of devices may perform the operations shown.

At 320, the UAV 305-c may transmit, and the UAV 305-a may receive, a first broadcast DAA message that includes a first application layer DAA payload. The application layer DAA payload may include a UE-specific ID that is unique to the UAV 305-c for the UTM system. In some examples, the UE-specific ID may include or be an example of a CAA-level ID that identifies the UAV 305-c. In some cases, the application layer DAA payload may further include an indication of a service type and one or more positioning parameters associated with the UAV 305-c, such as a position of the UAV 305-c, a velocity of the UAV 305-c, a heading direction of the UAV 305-c, or a combination thereof. The service type may be an A2X service type.

At 325, the UAV 305-b may transmit, and the UAV 305-a may receive, a second broadcast DAA message that includes a second application layer DAA payload. The application layer DAA payload may include a UE-specific ID that is unique to the UAV 305-b for the UTM system. In some examples, the UE-specific ID may include or be an example of a CAA-level ID that identifies the UAV 305-b. In some cases, the application layer DAA payload may further include an indication of a service type and one or more positioning parameters associated with the UAV 305-b, such as a position of the UAV 305-b, a velocity of the UAV 305-b, a heading direction of the UAV 305-b, or a combination thereof. The service type may be an A2X service type.

At 330, the UAV 305-a may determine whether a possible collision scenario exists with the UAV 305-c, the UAV 305-b, or both, based on the broadcast DAAs received at 320 and 325. For example, the UAV 305-a may pass the first application layer DAA payload to an application layer of the UAV 305-a. The application layer may compare the information included in the first application layer DAA payload with a trajectory and a position of the UAV 305-a to detect a conflict (e.g., a potential collision scenario) with the UAV 305-c. In the example of FIG. 3, the application layer may detect no conflict with the UAV 305-c.

The UAV 305-a may pass the second application layer DAA payload to the application layer of the UAV 305-a. The application layer may compare the information included in the second application layer DAA payload with the trajectory and the position of the UAV 305-a to detect a conflict with the UAV 305-b. In the example of FIG. 3, the application layer may detect a conflict (e.g., a potential collision scenario) with the UAV 305-b. Based on detecting the conflict, the application layer of the UAV 305-a may initiate a collision avoidance or conflict resolution (e.g., DAA deconfliction) procedure with the UAV 305-b.

At 335, the UAV 305-a may select a unicast communication mode for the collision avoidance or conflict resolution procedure with the UAV 305-b (e.g., based on input received from the application layer at 330 and an associated A2X policy). Based on selecting the unicast communication mode, the UAV 305-a may initiate (e.g., trigger) a unicast link establishment procedure for unicast communication with the UAV 305-b.

At 340, the UAV 305-a may derive an application layer ID for the UAV 305-b based on the UE-specific ID (e.g., the CAA-level ID) indicated in the broadcast DAA message at 325. The application layer ID may be associated with the A2X service type. In some examples, the UAV 305-a may derive the application layer ID for the UAV 305-b using a mapping (e.g., a one-to-one mapping) between the UE-specific ID and the application layer ID. In some cases, the UE-specific ID (e.g., the CAA-level ID) may be used as the application layer ID.

At 345, the UAV 305-a may transmit, and the UAV 305-b may receive, a DCR message including a request to establish an A2X unicast link. The DCR message may additionally indicate the application layer ID derived at 340. The DCR message may be transmitted at 345 as part of the unicast link establishment procedure with the UAV 305-b. In some cases, the UAV 305-a may transmit the DCR message at 345 based on a metric satisfying a threshold, where the metric is determined from a trajectory of the UAV 305-a and the one or more positioning parameters included in the broadcast DAA message at 325.

At 350, the UAV 305-b may transmit, and the UAV 305-a may receive, a link establishment message in response to receiving the DCR message at 345. The UAV 305-a and the UAV 305-b may establish a unicast link based on the link establishment message.

At 355, the UAV 305-a and the UAV 305-b may communicate A2X unicast messages with one another via the established unicast link according to the A2X service type. The A2X unicast messages may include at least one DAA message and, in some examples, one or more BRID messages.

FIG. 4 shows an example of a process flow 400 that supports unicast A2X communications in accordance with one or more aspects of the present disclosure. The process flow 400 may implement aspects of wireless communications systems 100 and 200, or may be implemented by aspects of the wireless communications system 100 and 200. For example, the process flow 400 may illustrate operations between UAVs 405, which may be examples of corresponding devices described herein. The process flow 400 illustrates an example A2X unicast link establishment procedure that is based on a collision detection procedure for a UTM system.

In the following description of the process flow 400, the operations between the UAVs 405 may be transmitted in a different order than the example order shown, or the operations performed by the UAVs 405 may be performed in different orders or at different times. Some operations may also be omitted from the process flow 400, and other operations may be added to the process flow 400. Additionally, although the process flow 400 illustrates the UAVs 405, it is to be understood that any device or combination of devices may perform the operations shown.

At 425, the UAV 405-b may transmit, and the UAV 405-a may receive, a broadcast DAA message that includes an application layer DAA payload. The application layer DAA payload may include a UE-specific ID that is unique to the UAV 405-b for the UTM system. In some examples, the UE-specific ID may include or be an example of a CAA-level ID that identifies the UAV 405-b. In some cases, the application layer DAA payload may further include an indication of a service type and one or more positioning parameters associated with the UAV 405-b, such as a position of the UAV 405-b, a velocity of the UAV 405-b, a heading direction of the UAV 405-b, or a combination thereof. The service type may be an A2X service type.

At 430, the UAV 405-a may determine whether a possible collision scenario exists with the UAV 405-b based on the broadcast DAA received at 425. For example, the UAV 405-a may pass the first application layer DAA payload to an application layer of the UAV 405-a. The application layer may compare the information included in the first application layer DAA payload with a trajectory and a position of the UAV 405-a to detect a conflict (e.g., a potential collision scenario) with the UAV 405-b. In the example of FIG. 4, the application layer may detect a conflict (e.g., a potential collision scenario) with the UAV 405-b. Based on detecting the conflict, the application layer of the UAV 405-a may initiate a collision avoidance or conflict resolution (e.g., DAA deconfliction) procedure with the UAV 405-b.

At 435, the UAV 405-a may select a unicast communication mode for the collision avoidance or conflict resolution procedure with the UAV 405-b (e.g., based on input received from the application layer at 430 and an associated A2X policy). Based on selecting the unicast communication mode, the UAV 405-a may initiate (e.g., trigger) a unicast link establishment procedure for unicast communication with the UAV 405-b.

At 440, the UAV 405-a may transmit, and the UAV 405-b may receive, a DCR message including a request to establish an A2X unicast link with the UAV 405-b. The UAV 405-a may transmit the DCR message as part of the unicast link establishment procedure with the UAV 405-b. For instance, the DCR message may be transmitted via PSSCH and may include one or more reference signals (e.g., DMRSs). The DCR message may exclude an application-layer ID of the UAV 405-b and associated with the service type.

The DCR message may indicate one or more proximity parameters associated with the UAV 405-a. In some examples, the one or more proximity parameters may include a position of the UAV 405-a, a velocity of the UAV 405-a, a heading direction of the UAV 405-a, or a combination thereof. In some cases, the one or more proximity parameters may include a transmit power of the DCR message, an EPRE of a DMRS included in the DCR message, or a combination thereof. In some examples, the one or more proximity parameters may include an application-layer ID that is unique to the UAV 405-a and derived from a CAA-level ID associated with the UAV 405-a.

At 445, the UAV 405-b may determine if a metric (e.g., a proximity metric) satisfies a threshold. The UAV 405-b may, for example, determine the metric based on a trajectory of the UAV 405-b and the one or more proximity parameters indicated in the DCR message, and may compare the metric to the threshold. If the one or more proximity parameters include the position of the UAV 405-a, the velocity of the UAV 405-a, the heading direction of the UAV 405-a, or a combination thereof, the metric may correspond to a distance between the UAV 405-a and the UAV 405-b, and the threshold may be a distance threshold. If the one or more proximity parameters include the transmit power of the DCR message, the EPRE of the DMRS included in the DCR message, or a combination thereof, the metric may correspond to a path loss associated with the DCR message and the threshold may be a path loss threshold. In this example, the UAV 405-b may measure an RSRP associated with receiving the DCR message and may determine the metric (e.g., the path loss) based on the one or more proximity parameters and the RSRP.

At 450, if the metric satisfies the threshold at 445, the UAV 405-b may transmit, and the UAV 405-a may receive, a link establishment message. For example, if the metric corresponds to the distance between the UAV 405-a and the UAV 405-b and the metric satisfies (e.g., is less than) the distance threshold, the UAV 405-a may determine that the UAV 405-a and the UAV 405-b are relatively close in proximity, and may proceed with the unicast link establishment procedure by transmitting the link establishment message. If the metric corresponds to the path loss of the DCR message and the metric satisfies (e.g., is less than) the path loss threshold, the UAV 405-a may determine that the path loss of the DCR message is relatively small; accordingly, the UAV 405-a may assume that the UAV 405-b is relatively close in proximity to the UAV 405-a and may proceed with the unicast link establishment procedure by transmitting the link establishment message. The UAV 405-a and the UAV 405-b may establish a unicast link based on the link establishment message.

At 455, the UAV 405-a and the UAV 405-b may communicate A2X unicast messages with one another via the established unicast link according to the A2X service type. The A2X unicast messages may include at least one DAA message and, in some examples, one or more BRID messages.

FIG. 5 shows an example of a process flow 500 that supports unicast A2X communications in accordance with one or more aspects of the present disclosure. The process flow 500 may implement aspects of wireless communications systems 100 and 200, or may be implemented by aspects of the wireless communications system 100 and 200. For example, the process flow 500 may illustrate operations between UAVs 505, which may be examples of corresponding devices described herein. The process flow 500 illustrates an example in which the UAVs 505 communicate via a unicast communication link according to one or more parameters for communicating unicast DAA messages.

In the following description of the process flow 500, the operations between the UAVs 505 may be transmitted in a different order than the example order shown, or the operations performed by the UAVs 505 may be performed in different orders or at different times. Some operations may also be omitted from the process flow 500, and other operations may be added to the process flow 500. Additionally, although the process flow 500 illustrates the UAVs 505, it is to be understood that any device or combination of devices may perform the operations shown.

At 525, the UAV 505-a and the UAV 505-b may establish a unicast communication link with one another according to a service type. The service type may be an A2X service type. The unicast communication link may be for communicating unicast DAA messages.

At 530, the UAV 505-a and the UAV 505-b may communicate at least one sidelink message via the unicast communication link.

In some examples, the UAV 505-b may transmit, and the UAV 505-a may receive, a first sidelink message of the at least one sidelink messages. Here, the first sidelink message may include or be an example of a UAI sidelink message (e.g., a UEAssistance InformationSidelink message). In some cases, the UAI sidelink message may indicate one or more positioning parameters associated with the UAV 505-b, such as a position of the UAV 505-b, a velocity of the UAV 505-b, a heading direction of the UAV 505-b, or a combination thereof. In such cases, the UAV 505-a may determine the one or more parameters for communicating unicast DAA messages based on the one or more positioning parameters. Additionally, in some examples, the UAV 505-a may transmit, and the UAV 505-b may receive, a second sidelink message that indicates the determined one or more parameters.

In other cases, the UAI sidelink message may indicate the one or more parameters for communicating unicast DAA messages. The one or more parameters may include, but are not limited to, a periodicity for the communication of the unicast DAA messages, a transmit power for the communication of the unicast DAA messages, or a combination thereof.

Alternatively, the UAV 505-a may transmit, and the UAV 505-b may receive, the first sidelink message of the at least one sidelink messages. Here, the first sidelink message may indicate the one or more parameters, including a periodicity for communicating the unicast DAA messages, positioning information associated with the UAV 505-b to be included in the one or more unicast DAA messages, a trigger event for communicating the one or more unicast DAA messages, or a combination thereof.

In some cases, the at least one sidelink message may include a first control message (e.g., a sidelink RRC message) that indicates a set of configurations for communicating unicast DAA messages, where each configuration of the set of configurations may be associated with one or more parameters. The UAV 505-a may transmit, and the UAV 505-b may receive, the first control message. Additionally, the at least one sidelink message may include a second control message (e.g., MAC-CE, SCI) that indicates a configuration from the set of configurations and indicates that the configuration is activated. The UAV 505-a may transmit, and the UAV 505-b may receive, the second control message.

In some examples, at 535, the UAV 505-a may transmit, and the UAV 505-b may receive, a message indicating a request for a DAA message (e.g., a request for the UAV 505-b to transmit a DAA message to the UAV 505-a via the unicast link).

In some examples, at 540, the UAV 505-a may transmit, and the UAV 505-b may receive, one or more PRSs.

At 545, the UAV 505-a and the UAV 505-b may communicate one or more unicast DAA messages according to the one or more parameters. For example, the UAV 505-a may transmit, and the UAV 505-b may receive, one or more unicast DAA messages via the unicast link. Additionally, or alternatively, the UAV 505-b may transmit, and the UAV 505-a may receive, one or more unicast DAA messages via the unicast link. In some examples, the UAV 505-b may transmit, and the UAV 505-a may receive, the one or more unicast DAA messages in response to the request for a DAA message at 535. In some cases, the UAV 505-b may transmit, and the UAV 505-a may receive, the one or more unicast DAA messages including positioning information associated with the UAV 505-b, where the positioning information is determined by the UAV 505-b based on the PRSs received at 540.

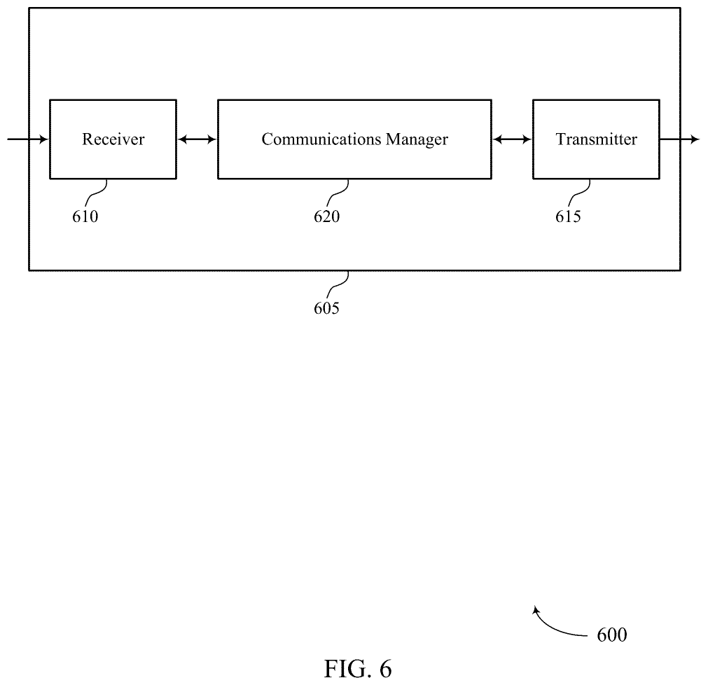

FIG. 6 shows a block diagram 600 of a device 605 that supports unicast A2X communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to unicast A2X communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to unicast A2X communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of unicast A2X communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving, from a second UE, a broadcast message that includes a UE-specific ID that is unique to the second UE for a UTM system. The communications manager 620 is capable of, configured to, or operable to support a means for transmitting a DCR message to the second UE in response to the broadcast message, where the DCR message includes an application-layer ID derived from the UE-specific ID included in the broadcast message, a service type associated with information for communication with the first UE, or both. The communications manager 620 is capable of, configured to, or operable to support a means for communicating unicast messages according to the service type with the second UE based on transmitting the DCR message to the second UE.

Additionally, or alternatively, the communications manager 620 may support wireless communication in accordance with examples as disclosed herein. For example, the communications manager 620 is capable of, configured to, or operable to support a means for transmitting, to a second UE, a broadcast message that includes a UE-specific ID that is unique to the first UE for a UTM system. The communications manager 620 is capable of, configured to, or operable to support a means for receiving a DCR message from the second UE in response to the broadcast message, where the DCR message includes an application-layer ID derived from the UE-specific ID included in the broadcast message, a service type associated with information for communication with the first UE, or both. The communications manager 620 is capable of, configured to, or operable to support a means for communicating unicast messages according to the service type with the second UE based on receiving the DCR message from the second UE.

Additionally, or alternatively, the communications manager 620 may support wireless communication in accordance with examples as disclosed herein. For example, the communications manager 620 is capable of, configured to, or operable to support a means for transmitting a DCR message associated with a service type, the DCR message including one or more proximity parameters associated with the first UE. The communications manager 620 is capable of, configured to, or operable to support a means for receiving, from a second UE in response to the DCR message, a link establishment message based on a metric determined from a trajectory of the second UE and the one or more proximity parameters associated with the first UE satisfying a threshold. The communications manager 620 is capable of, configured to, or operable to support a means for communicating unicast messages with the second UE according to the service type based on receiving the link establishment message from the second UE.

Additionally, or alternatively, the communications manager 620 may support wireless communication in accordance with examples as disclosed herein. For example, the communications manager 620 is capable of, configured to, or operable to support a means for transmitting a broadcast message that includes a UE-specific ID that is unique to the first UE for a UTM system. The communications manager 620 is capable of, configured to, or operable to support a means for receiving, from a second UE in response to the broadcast message, a DCR message associated with a service type, the DCR message including one or more proximity parameters associated with the second UE. The communications manager 620 is capable of, configured to, or operable to support a means for transmitting, to the second UE in response to the DCR message, a link establishment message based on a metric determined from a trajectory of the first UE and the one or more proximity parameters associated with the second UE satisfying a threshold. The communications manager 620 is capable of, configured to, or operable to support a means for communicating unicast messages with the second UE according to the service type based on transmitting the link establishment message to the second UE.

Additionally, or alternatively, the communications manager 620 may support wireless communication in accordance with examples as disclosed herein. For example, the communications manager 620 is capable of, configured to, or operable to support a means for establishing a communication link with a second UE according to a service type. The communications manager 620 is capable of, configured to, or operable to support a means for communicating, with the second UE, a sidelink message indicating one or more parameters for communication of unicast DAA messages. The communications manager 620 is capable of, configured to, or operable to support a means for communicating, with the second UE, one or more unicast DAA messages according to the one or more parameters.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for improved A2X services and communications. For example, the device 605 may be capable of establishing an A2X unicast link with another device and communicating via the A2X unicast link according to a configuration for A2X unicast communications, thereby reducing processing, reducing power consumption, and improving communications efficiency at the device 605.

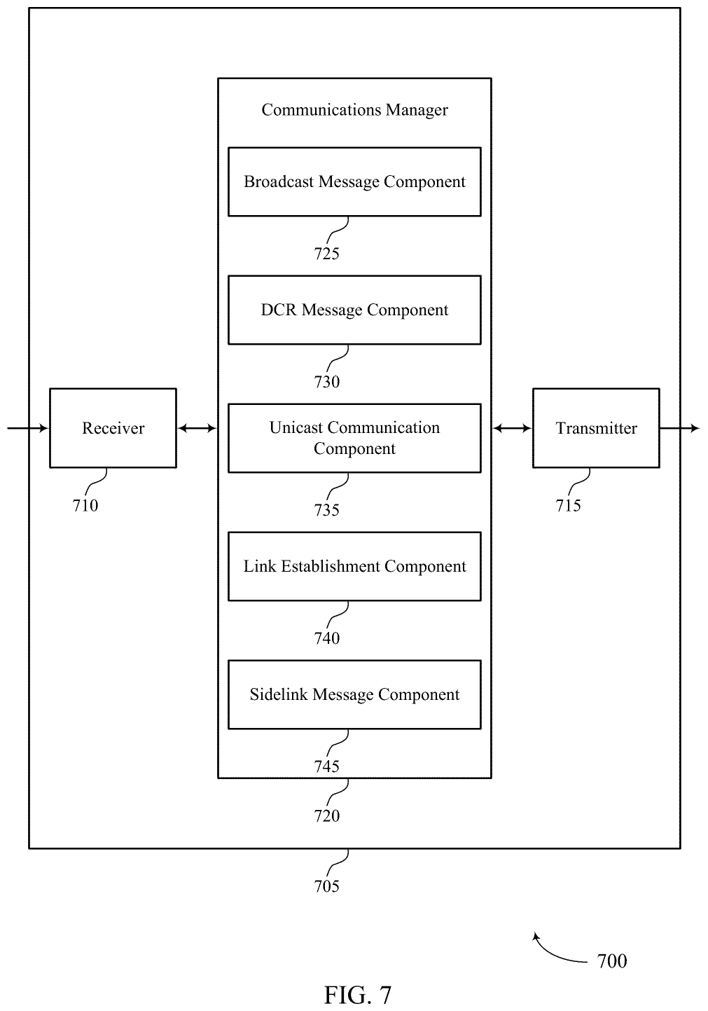

FIG. 7 shows a block diagram 700 of a device 705 that supports unicast A2X communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to unicast A2X communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to unicast A2X communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of unicast A2X communications as described herein. For example, the communications manager 720 may include a broadcast message component 725, a DCR message component 730, a unicast communication component 735, a link establishment component 740, a sidelink message component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The broadcast message component 725 is capable of, configured to, or operable to support a means for receiving, from a second UE, a broadcast message that includes a UE-specific ID that is unique to the second UE for a UTM system. The DCR message component 730 is capable of, configured to, or operable to support a means for transmitting a DCR message to the second UE in response to the broadcast message, where the DCR message includes an application-layer ID derived from the UE-specific ID included in the broadcast message, a service type associated with information for communication with the first UE, or both. The unicast communication component 735 is capable of, configured to, or operable to support a means for communicating unicast messages according to the service type with the second UE based on transmitting the DCR message to the second UE.

Additionally, or alternatively, the communications manager 720 may support wireless communication in accordance with examples as disclosed herein. The broadcast message component 725 is capable of, configured to, or operable to support a means for transmitting, to a second UE, a broadcast message that includes a UE-specific ID that is unique to the first UE for a UTM system. The DCR message component 730 is capable of, configured to, or operable to support a means for receiving a DCR message from the second UE in response to the broadcast message, where the DCR message includes an application-layer ID derived from the UE-specific ID included in the broadcast message, a service type associated with information for communication with the first UE, or both. The unicast communication component 735 is capable of, configured to, or operable to support a means for communicating unicast messages according to the service type with the second UE based on receiving the DCR message from the second UE.

Additionally, or alternatively, the communications manager 720 may support wireless communication in accordance with examples as disclosed herein. The DCR message component 730 is capable of, configured to, or operable to support a means for transmitting a DCR message associated with a service type, the DCR message including one or more proximity parameters associated with the first UE. The link establishment component 740 is capable of, configured to, or operable to support a means for receiving, from a second UE in response to the DCR message, a link establishment message based on a metric determined from a trajectory of the second UE and the one or more proximity parameters associated with the first UE satisfying a threshold. The unicast communication component 735 is capable of, configured to, or operable to support a means for communicating unicast messages with the second UE according to the service type based on receiving the link establishment message from the second UE.

Additionally, or alternatively, the communications manager 720 may support wireless communication in accordance with examples as disclosed herein. The broadcast message component 725 is capable of, configured to, or operable to support a means for transmitting a broadcast message that includes a UE-specific ID that is unique to the first UE for a UTM system. The DCR message component 730 is capable of, configured to, or operable to support a means for receiving, from a second UE in response to the broadcast message, a DCR message associated with a service type, the DCR message including one or more proximity parameters associated with the second UE. The link establishment component 740 is capable of, configured to, or operable to support a means for transmitting, to the second UE in response to the DCR message, a link establishment message based on a metric determined from a trajectory of the first UE and the one or more proximity parameters associated with the second UE satisfying a threshold. The unicast communication component 735 is capable of, configured to, or operable to support a means for communicating unicast messages with the second UE according to the service type based on transmitting the link establishment message to the second UE.

Additionally, or alternatively, the communications manager 720 may support wireless communication in accordance with examples as disclosed herein. The link establishment component 740 is capable of, configured to, or operable to support a means for establishing a communication link with a second UE according to a service type. The sidelink message component 745 is capable of, configured to, or operable to support a means for communicating, with the second UE, a sidelink message indicating one or more parameters for communication of unicast DAA messages. The unicast communication component 735 is capable of, configured to, or operable to support a means for communicating, with the second UE, one or more unicast DAA messages according to the one or more parameters.

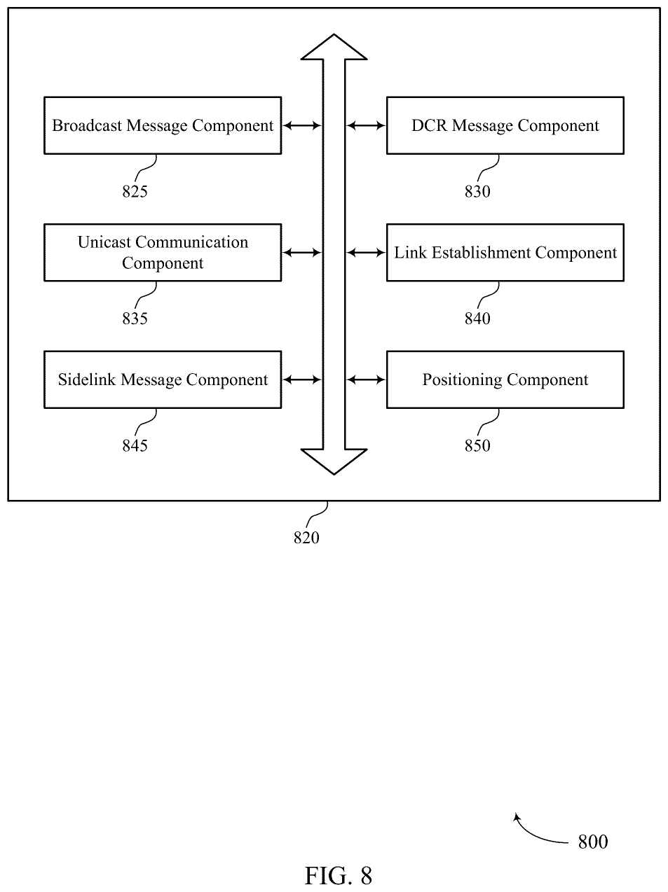

FIG. 8 shows a block diagram 800 of a communications manager 820 that supports unicast A2X communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of unicast A2X communications as described herein. For example, the communications manager 820 may include a broadcast message component 825, a DCR message component 830, a unicast communication component 835, a link establishment component 840, a sidelink message component 845, a positioning component 850, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The broadcast message component 825 is capable of, configured to, or operable to support a means for receiving, from a second UE, a broadcast message that includes a UE-specific ID that is unique to the second UE for a UTM system. The DCR message component 830 is capable of, configured to, or operable to support a means for transmitting a DCR message to the second UE in response to the broadcast message, where the DCR message includes an application-layer ID derived from the UE-specific ID included in the broadcast message, a service type associated with information for communication with a first UE, or both. The unicast communication component 835 is capable of, configured to, or operable to support a means for communicating unicast messages according to the service type with the second UE based on transmitting the DCR message to the second UE.

In some examples, the service type includes an A2X service type.

In some examples, the broadcast message is a broadcast DAA message that further includes one or more positioning parameters associated with the second UE, the one or more positioning parameters including a position of the second UE, a velocity of the second UE, a heading direction of the second UE, or a combination thereof. In some examples, the DCR message is transmitted to the second UE based on a metric determined from a trajectory of the second UE and the one or more positioning parameters associated with the second UE satisfying a threshold.

In some examples, the DCR message is transmitted as part of a unicast link establishment procedure with the second UE. In some examples, at least one unicast message of the unicast messages includes a unicast DAA message. In some examples, the UE-specific ID includes a CAA-level ID that identifies the second UE.

Additionally, or alternatively, the communications manager 820 may support wireless communication in accordance with examples as disclosed herein. In some examples, the broadcast message component 825 is capable of, configured to, or operable to support a means for transmitting, to a second UE, a broadcast message that includes a UE-specific ID that is unique to the first UE for a UTM system. In some examples, the DCR message component 830 is capable of, configured to, or operable to support a means for receiving a DCR message from the second UE in response to the broadcast message, where the DCR message includes an application-layer ID derived from the UE-specific ID included in the broadcast message, a service type associated with information for communication with a first UE, or both. In some examples, the unicast communication component 835 is capable of, configured to, or operable to support a means for communicating unicast messages according to the service type with the second UE based on receiving the DCR message from the second UE.

In some examples, the service type includes an A2X service type.

In some examples, the broadcast message is a broadcast DAA message that further includes one or more positioning parameters associated with the first UE, the one or more positioning parameters including a position of the first UE, a velocity of the first UE, a heading direction of the first UE, or a combination thereof. In some examples, the DCR message is received as part of a unicast link establishment procedure with the second UE. In some examples, at least one unicast message of the unicast messages includes a unicast DAA message. In some examples, the UE-specific ID includes a CAA-level ID that identifies the first UE.

Additionally, or alternatively, the communications manager 820 may support wireless communication in accordance with examples as disclosed herein. In some examples, the DCR message component 830 is capable of, configured to, or operable to support a means for transmitting a DCR message associated with a service type, the DCR message including one or more proximity parameters associated with the first UE. The link establishment component 840 is capable of, configured to, or operable to support a means for receiving, from a second UE in response to the DCR message, a link establishment message based on a metric determined from a trajectory of the second UE and the one or more proximity parameters associated with the first UE satisfying a threshold. In some examples, the unicast communication component 835 is capable of, configured to, or operable to support a means for communicating unicast messages with the second UE according to the service type based on receiving the link establishment message from the second UE.

In some examples, the service type includes an A2X service type.

In some examples, the one or more proximity parameters associated with the first UE include a position of the first UE, a velocity of the first UE, a heading direction of the first UE, or a combination thereof. In some examples, the threshold includes a distance threshold.

In some examples, the one or more proximity parameters associated with the first UE include a transmit power of the DCR message, an EPRE of a reference signal included in the DCR message, or a combination thereof. In some examples, the threshold includes a path loss threshold.

In some examples, the broadcast message component 825 is capable of, configured to, or operable to support a means for transmitting a broadcast message that includes a set of positioning parameters associated with the first UE and a CAA-level ID that identifies the first UE, where the one or more proximity parameters associated with the first UE include an application-layer ID that is unique to the first UE, the application-layer ID associated with a service type and derived from the CAA-level ID included in the broadcast message.

In some examples, the broadcast message component 825 is capable of, configured to, or operable to support a means for receiving one or more broadcast messages from one or more other UEs, where each broadcast message of the one or more broadcast messages includes a UE-specific ID and a set of proximity parameters associated with a respective UE of the one or more other UEs, and where the DCR message is transmitted as part of a unicast link establishment procedure with the second UE.

In some examples, the UE-specific ID includes a CAA-level ID that identifies the second UE. In some examples, the one or more broadcast messages include one or more broadcast DAA messages. In some examples, the DCR message excludes an application-layer ID associated with the service type. In some examples, at least one unicast message of the unicast messages includes a unicast DAA message.

Additionally, or alternatively, the communications manager 820 may support wireless communication in accordance with examples as disclosed herein. In some examples, the broadcast message component 825 is capable of, configured to, or operable to support a means for transmitting a broadcast message that includes a UE-specific ID that is unique to the first UE for a UTM system. In some examples, the DCR message component 830 is capable of, configured to, or operable to support a means for receiving, from a second UE in response to the broadcast message, a DCR message associated with a service type, the DCR message including one or more proximity parameters associated with the second UE. In some examples, the link establishment component 840 is capable of, configured to, or operable to support a means for transmitting, to the second UE in response to the DCR message, a link establishment message based on a metric determined from a trajectory of the first UE and the one or more proximity parameters associated with the second UE satisfying a threshold. In some examples, the unicast communication component 835 is capable of, configured to, or operable to support a means for communicating unicast messages with the second UE according to the service type based on transmitting the link establishment message to the second UE.

In some examples, the service type includes an A2X service type.

In some examples, the one or more proximity parameters associated with the second UE include a position of the second UE, and the positioning component 850 is capable of, configured to, or operable to support a means for determining the metric including a distance between the second UE and the first UE, where the threshold includes a distance threshold.

In some examples, the one or more proximity parameters associated with the second UE include a transmit power of the DCR message, and the positioning component 850 is capable of, configured to, or operable to support a means for measuring an RSRP associated with receiving the DCR message. In some examples, the one or more proximity parameters associated with the second UE include a transmit power of the DCR message, and the positioning component 850 is capable of, configured to, or operable to support a means for determining the metric including a path loss associated with the DCR message based on the RSRP and the one or more proximity parameters, where the threshold includes a path loss threshold.

In some examples, the broadcast message component 825 is capable of, configured to, or operable to support a means for receiving, from the second UE, a broadcast message that includes a set of positioning parameters associated with the second UE and a CAA-level ID that identifies the second UE, where the one or more proximity parameters associated with the second UE include an application-layer ID that is unique to the first UE, the application-layer ID associated with a service type and derived from the CAA-level ID included in the broadcast message. In some examples, the positioning component 850 is capable of, configured to, or operable to support a means for determining the metric including a distance between the first UE and the second UE based on the set of positioning parameters and the one or more proximity parameters, where the threshold includes a distance threshold.

In some examples, the UE-specific ID includes a CAA-level ID that identifies the first UE.

In some examples, the DCR message excludes an application-layer ID associated with the service type. In some examples, the broadcast message includes a set of proximity parameters associated with the first UE. In some examples, at least one unicast message of the unicast messages includes a unicast DAA message.

Additionally, or alternatively, the communications manager 820 may support wireless communication in accordance with examples as disclosed herein. In some examples, the link establishment component 840 is capable of, configured to, or operable to support a means for establishing a communication link with a second UE according to a service type. The sidelink message component 845 is capable of, configured to, or operable to support a means for communicating, with the second UE, a sidelink message indicating one or more parameters for communication of unicast DAA messages. In some examples, the unicast communication component 835 is capable of, configured to, or operable to support a means for communicating, with the second UE, one or more unicast DAA messages according to the one or more parameters.

In some examples, the service type includes an A2X service type.

In some examples, to support communicating the sidelink message, the sidelink message component 845 is capable of, configured to, or operable to support a means for receiving the UAI sidelink message from the second UE. In some examples, to support communicating the sidelink message, the unicast communication component 835 is capable of, configured to, or operable to support a means for determining the one or more parameters for the communication of unicast DAA messages based on the one or more positioning parameters associated with the second UE.

In some examples, to support communicating the sidelink message, the sidelink message component 845 is capable of, configured to, or operable to support a means for receiving the UAI sidelink message from the second UE. In some examples, to support communicating the one or more unicast DAA messages, the unicast communication component 835 is capable of, configured to, or operable to support a means for receiving the one or more unicast DAA messages from the second UE.

In some examples, to support communicating the sidelink message, the sidelink message component 845 is capable of, configured to, or operable to support a means for transmitting the sidelink message to the second UE. In some examples, to support communicating the one or more unicast DAA messages, the unicast communication component 835 is capable of, configured to, or operable to support a means for receiving the one or more unicast DAA messages from the second UE.

In some examples, to support communicating the one or more unicast DAA messages, the unicast communication component 835 is capable of, configured to, or operable to support a means for transmitting, to the second UE, a request for a unicast DAA message of the one or more unicast DAA messages. In some examples, to support communicating the one or more unicast DAA messages, the unicast communication component 835 is capable of, configured to, or operable to support a means for receiving the unicast DAA message from the second UE based on the request.

In some examples, to support communicating the one or more unicast DAA messages, the positioning component 850 is capable of, configured to, or operable to support a means for transmitting, to the second UE, one or more positioning reference signals (PRSs). In some examples, to support communicating the one or more unicast DAA messages, the unicast communication component 835 is capable of, configured to, or operable to support a means for receiving the one or more unicast DAA messages from the second UE based on the one or more PRSs.

In some examples, the unicast communication component 835 is capable of, configured to, or operable to support a means for transmitting, to the second UE, a first control message indicating a set of configurations for the service type. In some examples, the unicast communication component 835 is capable of, configured to, or operable to support a means for transmitting, to the second UE, a second control message indicating that a configuration from the set of configurations is activated, the configuration including the one or more parameters.

In some examples, the first control message includes an RRC message and the second control message includes a MAC-CE message or an SCI message.

In some examples, to support communicating the sidelink message, the sidelink message component 845 is capable of, configured to, or operable to support a means for transmitting the UAI sidelink message to the second UE.

In some examples, to support communicating the one or more unicast DAA messages, the unicast communication component 835 is capable of, configured to, or operable to support a means for transmitting the one or more unicast DAA messages to the second UE.

In some examples, to support communicating the sidelink message, the sidelink message component 845 is capable of, configured to, or operable to support a means for receiving the sidelink message from the second UE.

In some examples, to support communicating the one or more unicast DAA messages, the unicast communication component 835 is capable of, configured to, or operable to support a means for transmitting the one or more unicast DAA messages to the second UE.

In some examples, to support communicating the one or more unicast DAA messages, the unicast communication component 835 is capable of, configured to, or operable to support a means for receiving, from the second UE, a request for a unicast DAA message of the one or more unicast DAA messages. In some examples, to support communicating the one or more unicast DAA messages, the unicast communication component 835 is capable of, configured to, or operable to support a means for transmitting the unicast DAA message to the second UE based on the request.

In some examples, to support communicating the one or more unicast DAA messages, the positioning component 850 is capable of, configured to, or operable to support a means for receiving, from the second UE, one or more positioning reference signals (PRSs). In some examples, to support communicating the one or more unicast DAA messages, the sidelink message component 845 is capable of, configured to, or operable to support a means for transmitting the one or more unicast DAA messages to the second UE, the one or more unicast DAA messages including positioning information associated with the first UE based on receiving the one or more PRSs.

In some examples, the unicast communication component 835 is capable of, configured to, or operable to support a means for receiving a first control message indicating a set of configurations for the service type. In some examples, the unicast communication component 835 is capable of, configured to, or operable to support a means for receiving a second control message indicating that a configuration from the set of configurations is activated, the configuration including the one or more parameters.

In some examples, the first control message includes an RRC message and the second control message includes a MAC-CE message or an SCI message.

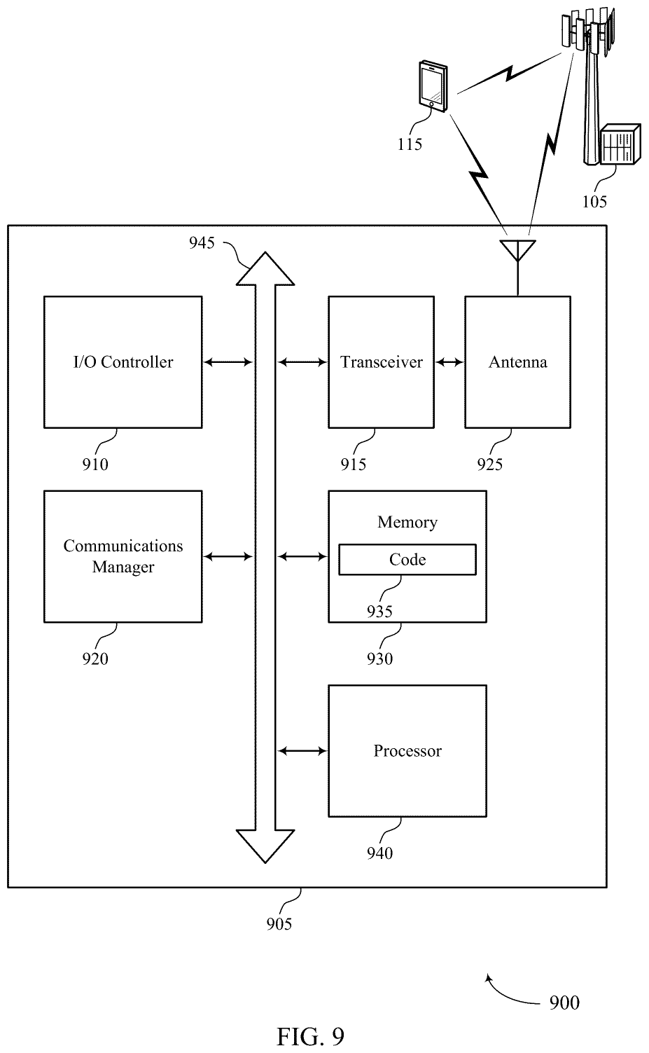

FIG. 9 shows a diagram of a system 900 including a device 905 that supports unicast A2X communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting unicast A2X communications). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving, from a second UE, a broadcast message that includes a UE-specific ID that is unique to the second UE for a UTM system. The communications manager 920 is capable of, configured to, or operable to support a means for transmitting a DCR message to the second UE in response to the broadcast message, where the DCR message includes an application-layer ID derived from the UE-specific ID included in the broadcast message, a service type associated with information for communication with the first UE, or both. The communications manager 920 is capable of, configured to, or operable to support a means for communicating unicast messages according to the service type with the second UE based on transmitting the DCR message to the second UE.

Additionally, or alternatively, the communications manager 920 may support wireless communication in accordance with examples as disclosed herein. For example, the communications manager 920 is capable of, configured to, or operable to support a means for transmitting, to a second UE, a broadcast message that includes a UE-specific ID that is unique to the first UE for a UTM system. The communications manager 920 is capable of, configured to, or operable to support a means for receiving a DCR message from the second UE in response to the broadcast message, where the DCR message includes an application-layer ID derived from the UE-specific ID included in the broadcast message, a service type associated with information for communication with the first UE, or both. The communications manager 920 is capable of, configured to, or operable to support a means for communicating unicast messages according to the service type with the second UE based on receiving the DCR message from the second UE.

Additionally, or alternatively, the communications manager 920 may support wireless communication in accordance with examples as disclosed herein. For example, the communications manager 920 is capable of, configured to, or operable to support a means for transmitting a DCR message associated with a service type, the DCR message including one or more proximity parameters associated with the first UE. The communications manager 920 is capable of, configured to, or operable to support a means for receiving, from a second UE in response to the DCR message, a link establishment message based on a metric determined from a trajectory of the second UE and the one or more proximity parameters associated with the first UE satisfying a threshold. The communications manager 920 is capable of, configured to, or operable to support a means for communicating unicast messages with the second UE according to the service type based on receiving the link establishment message from the second UE.

Additionally, or alternatively, the communications manager 920 may support wireless communication in accordance with examples as disclosed herein. For example, the communications manager 920 is capable of, configured to, or operable to support a means for transmitting a broadcast message that includes a UE-specific ID that is unique to the first UE for a UTM system. The communications manager 920 is capable of, configured to, or operable to support a means for receiving, from a second UE in response to the broadcast message, a DCR message associated with a service type, the DCR message including one or more proximity parameters associated with the second UE. The communications manager 920 is capable of, configured to, or operable to support a means for transmitting, to the second UE in response to the DCR message, a link establishment message based on a metric determined from a trajectory of the first UE and the one or more proximity parameters associated with the second UE satisfying a threshold. The communications manager 920 is capable of, configured to, or operable to support a means for communicating unicast messages with the second UE according to the service type based on transmitting the link establishment message to the second UE.

Additionally, or alternatively, the communications manager 920 may support wireless communication in accordance with examples as disclosed herein. For example, the communications manager 920 is capable of, configured to, or operable to support a means for establishing a communication link with a second UE according to a service type. The communications manager 920 is capable of, configured to, or operable to support a means for communicating, with the second UE, a sidelink message indicating one or more parameters for communication of unicast DAA messages. The communications manager 920 is capable of, configured to, or operable to support a means for communicating, with the second UE, one or more unicast DAA messages according to the one or more parameters.

By including or configuring the communications manager 920 in accordance with examples as described herein, the device 905 may support techniques for improved A2X services and communications. For example, the techniques described herein support efficient A2X unicast link establishment procedures between devices such as the device 905, which may improve coordination between devices and reduce latency. Additionally, the techniques described herein support optimized parameters and configurations for communicating via the A2X unicast link, which may enable DAA messages to be communicated with increased reliability and efficiency.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of unicast A2X communications as described herein, or the at least one processor 940 and the at least one memory 930 may be otherwise configured to, individually or collectively, perform or support such operations.

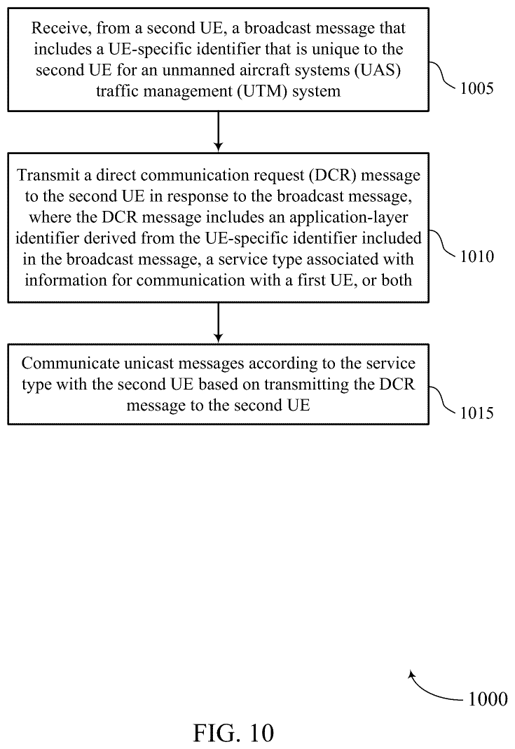

FIG. 10 shows a flowchart illustrating a method 1000 that supports unicast A2X communications in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving, from a second UE, a broadcast message that includes a UE-specific ID that is unique to the second UE for a UTM system. The operations of block 1005 may be performed in accordance with examples as disclosed herein. In some examples, aspects of the operations of 1005 may be performed by a broadcast message component 825 as described with reference to FIG. 8.

At 1010, the method may include transmitting a DCR message to the second UE in response to the broadcast message, where the DCR message includes an application-layer ID derived from the UE-specific ID included in the broadcast message, a service type associated with information for communication with the first UE, or both. The operations of block 1010 may be performed in accordance with examples as disclosed herein. In some examples, aspects of the operations of 1010 may be performed by a DCR message component 830 as described with reference to FIG. 8.

At 1015, the method may include communicating unicast messages according to the service type with the second UE based on transmitting the DCR message to the second UE. The operations of block 1015 may be performed in accordance with examples as disclosed herein. In some examples, aspects of the operations of 1015 may be performed by a unicast communication component 835 as described with reference to FIG. 8.

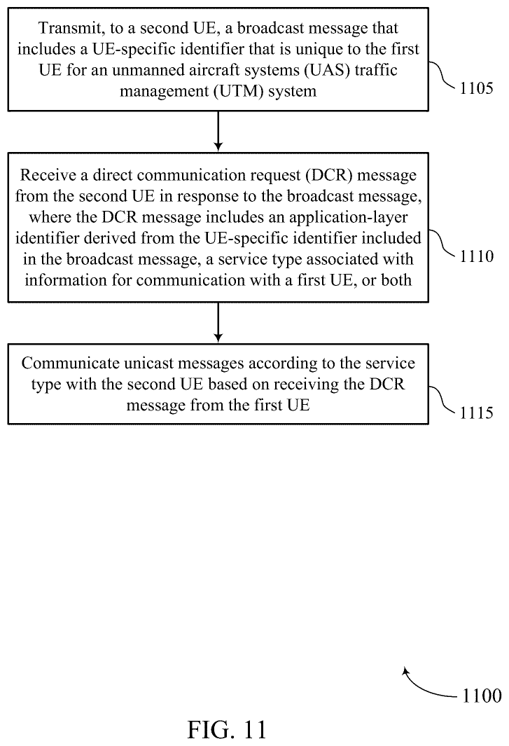

FIG. 11 shows a flowchart illustrating a method 1100 that supports unicast A2X communications in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting, to a second UE, a broadcast message that includes a UE-specific ID that is unique to the first UE for a UTM system. The operations of block 1105 may be performed in accordance with examples as disclosed herein. In some examples, aspects of the operations of 1105 may be performed by a broadcast message component 825 as described with reference to FIG. 8.

At 1110, the method may include receiving a DCR message from the second UE in response to the broadcast message, where the DCR message includes an application-layer ID derived from the UE-specific ID included in the broadcast message, a service type associated with information for communication with a first UE, or both. The operations of block 1110 may be performed in accordance with examples as disclosed herein. In some examples, aspects of the operations of 1110 may be performed by a DCR message component 830 as described with reference to FIG. 8.

At 1115, the method may include communicating unicast messages according to the service type with the second UE based on receiving the DCR message from the second UE. The operations of block 1115 may be performed in accordance with examples as disclosed herein. In some examples, aspects of the operations of 1115 may be performed by a unicast communication component 835 as described with reference to FIG. 8.

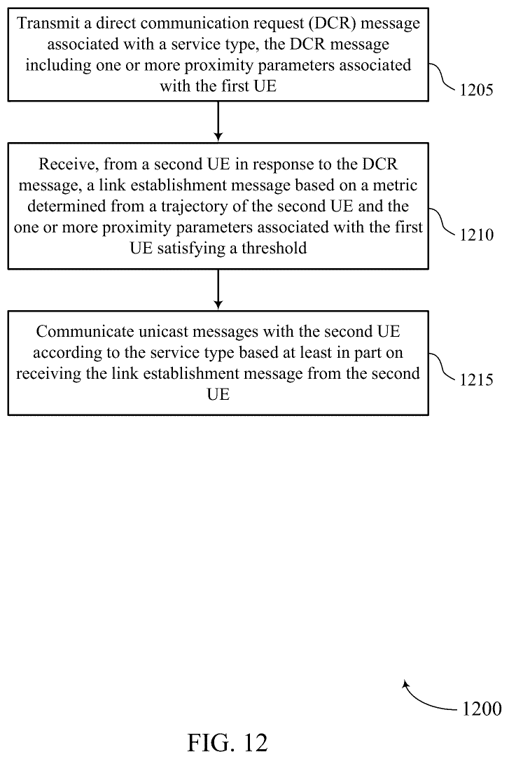

FIG. 12 shows a flowchart illustrating a method 1200 that supports unicast A2X communications in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include transmitting a DCR message associated with a service type, the DCR message including one or more proximity parameters associated with the first UE. The operations of block 1205 may be performed in accordance with examples as disclosed herein. In some examples, aspects of the operations of 1205 may be performed by a DCR message component 830 as described with reference to FIG. 8.

At 1210, the method may include receiving, from a second UE in response to the DCR message, a link establishment message based on a metric determined from a trajectory of the second UE and the one or more proximity parameters associated with the first UE satisfying a threshold. The operations of block 1210 may be performed in accordance with examples as disclosed herein. In some examples, aspects of the operations of 1210 may be performed by a link establishment component 840 as described with reference to FIG. 8.

At 1215, the method may include communicating unicast messages with the second UE according to the service type based at least in part on receiving the link establishment message from the second UE. The operations of block 1215 may be performed in accordance with examples as disclosed herein. In some examples, aspects of the operations of 1215 may be performed by a unicast communication component 835 as described with reference to FIG. 8.

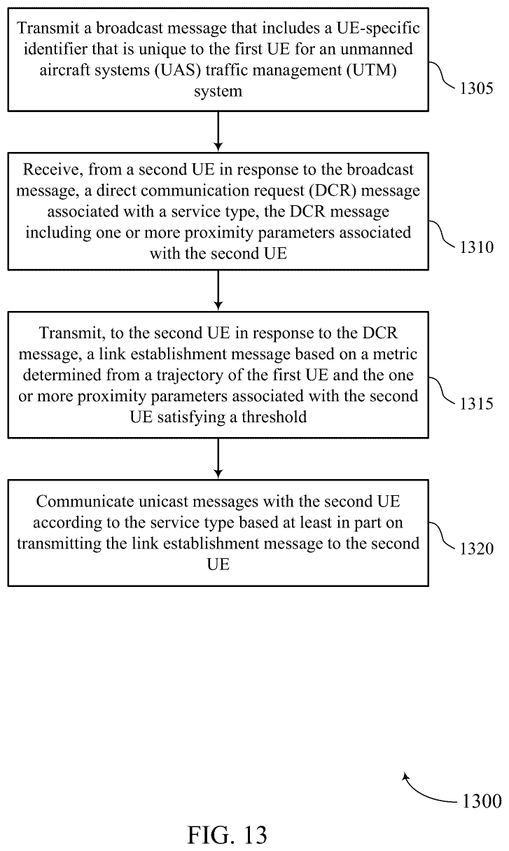

FIG. 13 shows a flowchart illustrating a method 1300 that supports unicast A2X communications in accordance with aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include transmitting a broadcast message that includes a UE-specific ID that is unique to the first UE for a UTM system. The operations of block 1305 may be performed in accordance with examples as disclosed herein. In some examples, aspects of the operations of 1305 may be performed by a broadcast message component 825 as described with reference to FIG. 8.

At 1310, the method may include receiving, from a second UE in response to the broadcast message, a DCR message associated with a service type, the DCR message including one or more proximity parameters associated with the second UE. The operations of block 1310 may be performed in accordance with examples as disclosed herein. In some examples, aspects of the operations of 1310 may be performed by a DCR message component 830 as described with reference to FIG. 8.

At 1315, the method may include transmitting, to the second UE in response to the DCR message, a link establishment message based on a metric determined from a trajectory of the first UE and the one or more proximity parameters associated with the second UE satisfying a threshold. The operations of block 1315 may be performed in accordance with examples as disclosed herein. In some examples, aspects of the operations of 1315 may be performed by a link establishment component 840 as described with reference to FIG. 8.

At 1320, the method may include communicating unicast messages with the second UE according to the service type based at least in part on transmitting the link establishment message to the second UE. The operations of block 1320 may be performed in accordance with examples as disclosed herein. In some examples, aspects of the operations of 1320 may be performed by a unicast communication component 835 as described with reference to FIG. 8.

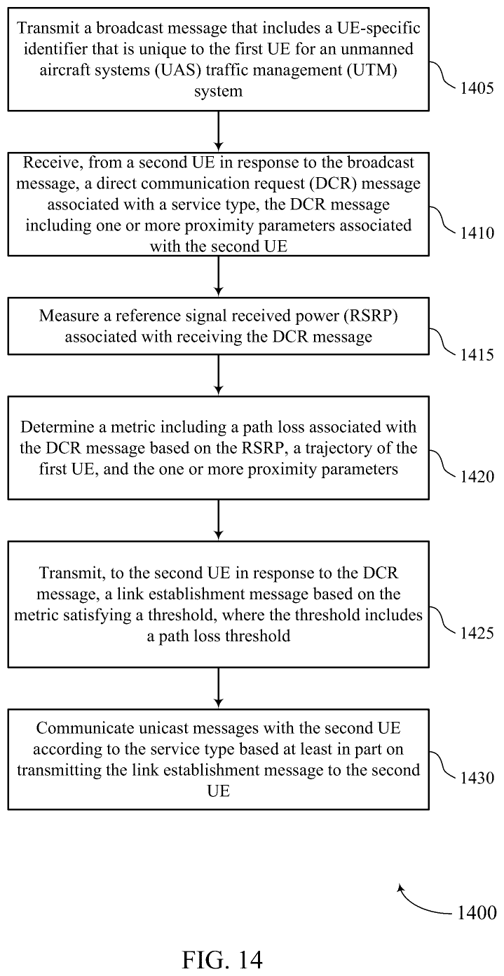

FIG. 14 shows a flowchart illustrating a method 1400 that supports unicast A2X communications in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a broadcast message that includes a UE-specific ID that is unique to the first UE for a UTM system. The operations of block 1405 may be performed in accordance with examples as disclosed herein. In some examples, aspects of the operations of 1405 may be performed by a broadcast message component 825 as described with reference to FIG. 8.

At 1410, the method may include receiving, from a second UE in response to the broadcast message, a DCR message associated with a service type, the DCR message including one or more proximity parameters associated with the second UE. The operations of block 1410 may be performed in accordance with examples as disclosed herein. In some examples, aspects of the operations of 1410 may be performed by a DCR message component 830 as described with reference to FIG. 8.

At 1415, the method may include measuring an RSRP associated with receiving the DCR message. The operations of block 1415 may be performed in accordance with examples as disclosed herein. In some examples, aspects of the operations of 1415 may be performed by a positioning component 850 as described with reference to FIG. 8.

At 1420, the method may include determining a metric including a path loss associated with the DCR message based on the RSRP, a trajectory of the first UE, and the one or more proximity parameters. The operations of block 1420 may be performed in accordance with examples as disclosed herein. In some examples, aspects of the operations of 1420 may be performed by a positioning component 850 as described with reference to FIG. 8.

At 1425, the method may include transmitting, to the second UE in response to the DCR message, a link establishment message based on the metric satisfying a threshold, where the threshold includes a path loss threshold. The operations of block 1425 may be performed in accordance with examples as disclosed herein. In some examples, aspects of the operations of 1425 may be performed by a link establishment component 840 as described with reference to FIG. 8.

At 1430, the method may include communicating unicast messages with the second UE according to the service type based at least in part on transmitting the link establishment message to the second UE. The operations of block 1430 may be performed in accordance with examples as disclosed herein. In some examples, aspects of the operations of 1430 may be performed by a unicast communication component 835 as described with reference to FIG. 8.

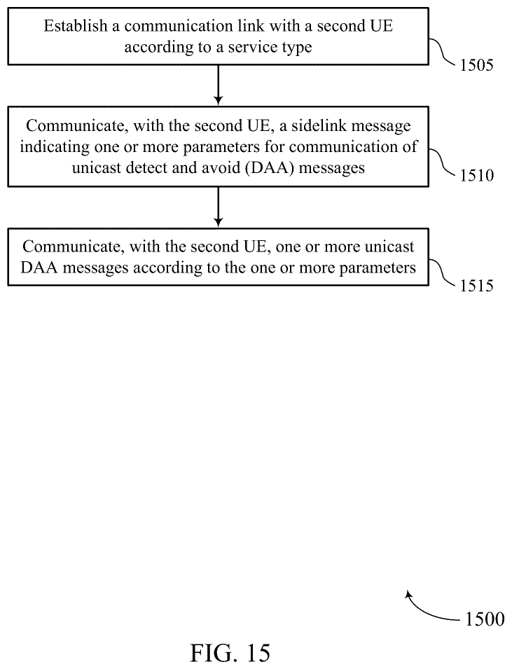

FIG. 15 shows a flowchart illustrating a method 1500 that supports unicast A2X communications in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include establishing a communication link with a second UE according to a service type. The operations of block 1505 may be performed in accordance with examples as disclosed herein. In some examples, aspects of the operations of 1505 may be performed by a link establishment component 840 as described with reference to FIG. 8.

At 1510, the method may include communicating, with the second UE, a sidelink message indicating one or more parameters for communication of unicast DAA messages. The operations of block 1510 may be performed in accordance with examples as disclosed herein. In some examples, aspects of the operations of 1510 may be performed by a sidelink message component 845 as described with reference to FIG. 8.

At 1515, the method may include communicating, with the second UE, one or more unicast DAA messages according to the one or more parameters. The operations of block 1515 may be performed in accordance with examples as disclosed herein. In some examples, aspects of the operations of 1515 may be performed by a unicast communication component 835 as described with reference to FIG. 8.

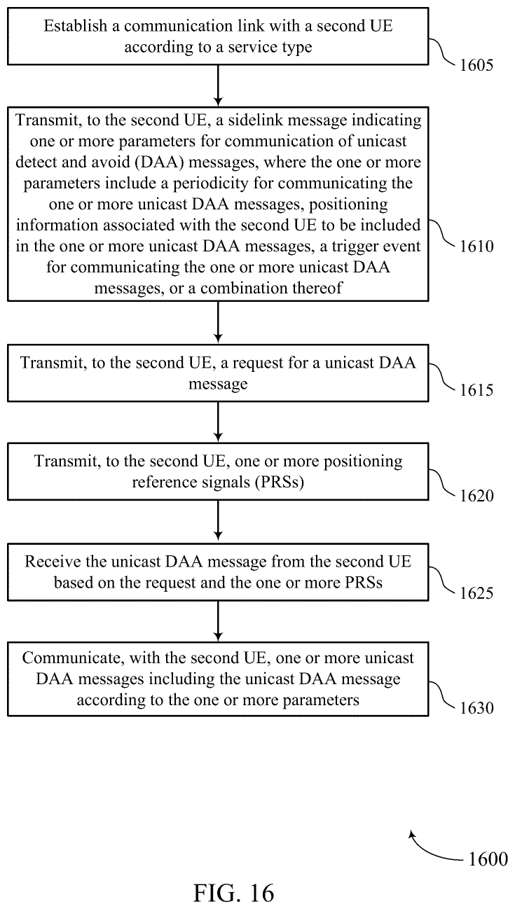

FIG. 16 shows a flowchart illustrating a method 1600 that supports unicast A2X communications in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include establishing a communication link with a second UE according to a service type. The operations of block 1605 may be performed in accordance with examples as disclosed herein. In some examples, aspects of the operations of 1605 may be performed by a link establishment component 840 as described with reference to FIG. 8.

At 1610, the method may include transmitting, to the second UE, a sidelink message indicating one or more parameters for communication of unicast DAA messages, where the one or more parameters include a periodicity for communicating the one or more unicast DAA messages, positioning information associated with the second UE to be included in the one or more unicast DAA messages, a trigger event for communicating the one or more unicast DAA messages, or a combination thereof. The operations of block 1610 may be performed in accordance with examples as disclosed herein. In some examples, aspects of the operations of 1610 may be performed by a sidelink message component 845 as described with reference to FIG. 8.

At 1615, the method may include transmitting, to the second UE, a request for a unicast DAA message of the one or more unicast DAA messages. The operations of block 1615 may be performed in accordance with examples as disclosed herein. In some examples, aspects of the operations of 1615 may be performed by a unicast communication component 835 as described with reference to FIG. 8.

At 1620, the method may include transmitting, to the second UE, one or more PRSs. The operations of block 1620 may be performed in accordance with examples as disclosed herein. In some examples, aspects of the operations of 1620 may be performed by a positioning component 850 as described with reference to FIG. 8.

At 1625, the method may include receiving the unicast DAA message from the second UE based on the request and the one or more PRSs. The operations of block 1625 may be performed in accordance with examples as disclosed herein. In some examples, aspects of the operations of 1625 may be performed by a unicast communication component 835 as described with reference to FIG. 8.

At 1630, the method may include communicating, with the second UE, one or more unicast DAA messages including the unicast DAA message according to the one or more parameters. The operations of block 1630 may be performed in accordance with examples as disclosed herein. In some examples, aspects of the operations of 1630 may be performed by a unicast communication component 835 as described with reference to FIG. 8.

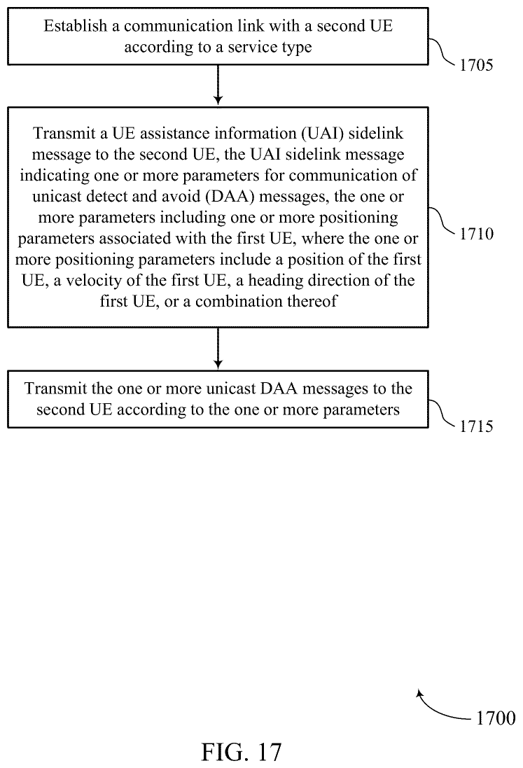

FIG. 17 shows a flowchart illustrating a method 1700 that supports unicast A2X communications in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include establishing a communication link with a second UE according to a service type. The operations of block 1705 may be performed in accordance with examples as disclosed herein. In some examples, aspects of the operations of 1705 may be performed by a link establishment component 840 as described with reference to FIG. 8.

At 1710, the method may include transmitting a UAI sidelink message to the second UE, the UAI sidelink message indicating one or more parameters for communication of unicast DAA messages, the one or more parameters including one or more positioning parameters associated with the first UE, where the one or more positioning parameters include a position of the first UE, a velocity of the first UE, a heading direction of the first UE, or a combination thereof. The operations of block 1710 may be performed in accordance with examples as disclosed herein. In some examples, aspects of the operations of 1710 may be performed by a sidelink message component 845 as described with reference to FIG. 8.

At 1715, the method may include transmitting the one or more unicast DAA messages to the second UE according to the one or more parameters. The operations of block 1715 may be performed in accordance with examples as disclosed herein. In some examples, aspects of the operations of 1715 may be performed by a unicast communication component 835 as described with reference to FIG. 8.

The following provides an overview of aspects of the present disclosure:

Aspect 1: A method for wireless communication by a first UE, comprising: receiving, from a second UE, a broadcast message that includes a UE-specific ID that is unique to the second UE for a UTM system; transmitting a DCR message to the second UE in response to the broadcast message, wherein the DCR message comprises an application-layer ID derived from the UE-specific ID included in the broadcast message, a service type associated with information for communication with the first UE, or both; and communicating unicast messages according to the service type with the second UE based at least in part on transmitting the DCR message to the second UE.

Aspect 2: The method of aspect 1, wherein the service type comprises an A2X service type.

Aspect 3: The method of any of aspects 1 through 2, wherein the broadcast message is a broadcast DAA message that further includes one or more positioning parameters associated with the second UE, the one or more positioning parameters comprising a position of the second UE, a velocity of the second UE, a heading direction of the second UE, or a combination thereof.

Aspect 4: The method of aspect 3, wherein the DCR message is transmitted to the second UE based at least in part on a metric determined from a trajectory of the second UE and the one or more positioning parameters associated with the second UE satisfying a threshold.

Aspect 5: The method of any of aspects 1 through 4, wherein the DCR message is transmitted as part of a unicast link establishment procedure with the second UE.

Aspect 6: The method of any of aspects 1 through 5, wherein at least one unicast message of the unicast messages comprises a unicast DAA message.

Aspect 7: The method of any of aspects 1 through 6, wherein the UE-specific ID comprises a CAA-level ID that identifies the second UE.

Aspect 8: A method for wireless communication by a second UE, comprising: transmitting, to a first UE, a broadcast message that includes a UE-specific ID that is unique to the second UE for a UTM system; receiving a DCR message from the first UE in response to the broadcast message, wherein the DCR message comprises an application-layer ID derived from the UE-specific ID included in the broadcast message, a service type associated with information for communication with the first UE, or both; and communicating unicast messages according to the service type with the first UE based at least in part on receiving the DCR message from the second UE.

Aspect 9: The method of aspect 8, wherein the service type comprises an A2X service type.

Aspect 10: The method of any of aspects 8 through 9, wherein the broadcast message is a broadcast DAA message that further includes one or more positioning parameters associated with the second UE, the one or more positioning parameters comprising a position of the second UE, a velocity of the second UE, a heading direction of the second UE, or a combination thereof.

Aspect 11: The method of aspect 10, wherein the DCR message is received as part of a unicast link establishment procedure with the first UE.

Aspect 12: The method of any of aspects 8 through 11, wherein at least one unicast message of the unicast messages comprises a unicast DAA message.

Aspect 13: The method of any of aspects 8 through 12, wherein the UE-specific ID comprises a CAA-level ID that identifies the second UE.

Aspect 14: A method for wireless communication by a first UE, comprising: transmitting a DCR message associated with a service type that includes one or more proximity parameters associated with the first UE; receiving, from a second UE in response to the DCR message, a link establishment message based at least in part on a metric determined from a trajectory of the second UE and the one or more proximity parameters associated with the first UE satisfying a threshold; and communicating unicast messages with the second UE according to the service type based at least in part on receiving the link establishment message from the second UE.

Aspect 15: The method of aspect 14, wherein the service type comprises an A2X service type.

Aspect 16: The method of any of aspects 14 through 15, wherein the one or more proximity parameters associated with the first UE comprise a position of the first UE, a velocity of the first UE, a heading direction of the first UE, or a combination thereof, and the threshold comprises a distance threshold.

Aspect 17: The method of any of aspects 14 through 16, wherein the one or more proximity parameters associated with the first UE comprise a transmit power of the DCR message, an EPRE of a reference signal included in the DCR message, or a combination thereof, and the threshold comprises a path loss threshold.

Aspect 18: The method of any of aspects 14 through 17, further comprising: transmitting a broadcast message that includes a set of positioning parameters associated with the first UE and a CAA-level ID that identifies the first UE, wherein the one or more proximity parameters associated with the first UE comprise an application-layer ID that is unique to the first UE, the application-layer ID associated with a service type and derived from the CAA-level ID included in the broadcast message.

Aspect 19: The method of any of aspects 14 through 18, further comprising: receiving one or more broadcast messages from one or more other UEs, wherein each broadcast message of the one or more broadcast messages includes a UE-specific ID and a set of proximity parameters associated with a respective UE of the one or more other UEs, and wherein the DCR message is transmitted as part of a unicast link establishment procedure with the second UE.

Aspect 20: The method of aspect 19, wherein the UE-specific ID comprises a CAA-level ID that identifies the second UE.

Aspect 21: The method of any of aspects 19 through 20, wherein the one or more broadcast messages comprise one or more broadcast DAA messages.

Aspect 22: The method of any of aspects 14 through 21, wherein the DCR message excludes an application-layer ID associated with the service type.

Aspect 23: The method of any of aspects 14 through 22, wherein at least one unicast message of the unicast messages comprises a unicast DAA message.

Aspect 24: A method for wireless communication by a second UE, comprising: transmitting a broadcast message that includes a UE-specific ID that is unique to the second UE for a UTM system; receiving, from a first UE in response to the broadcast message, a DCR message associated with a service type that includes one or more proximity parameters associated with the first UE; transmitting, to the first UE in response to the DCR message, a link establishment message based at least in part on a metric determined from a trajectory of the second UE and the one or more proximity parameters associated with the first UE satisfying a threshold; and communicating unicast messages with the first UE according to the service type based at least in part on transmitting the link establishment message to the first UE.

Aspect 25: The method of aspect 24, wherein the service type comprises an A2X service type.

Aspect 26: The method of any of aspects 24 through 25, wherein the one or more proximity parameters associated with the first UE comprise a position of the first UE, a velocity of the first UE, a heading direction of the first UE, or a combination thereof, the method further comprising: determining the metric including a distance between the first UE and the second UE, wherein the threshold comprises a distance threshold.

Aspect 27: The method of any of aspects 24 through 26, wherein the one or more proximity parameters associated with the first UE comprise a transmit power of the DCR message, an EPRE of a reference signal included in the DCR message, or a combination thereof, the method further comprising: measuring a reference signal received power (RSRP) associated with receiving the DCR message; and determining the metric including a path loss associated with the DCR message based at least in part on the RSRP and the one or more proximity parameters, wherein the threshold comprises a path loss threshold.

Aspect 28: The method of any of aspects 24 through 27, further comprising: receiving, from the first UE, a broadcast message that includes a set of positioning parameters associated with the first UE and a CAA-level ID that identifies the first UE, wherein the one or more proximity parameters associated with the first UE comprise an application-layer ID that is unique to the first UE, the application-layer ID associated with a service type and derived from the CAA-level ID included in the broadcast message; and determining the metric including a distance between the first UE and the second UE based at least in part on the set of positioning parameters and the one or more proximity parameters, wherein the threshold comprises a distance threshold.

Aspect 29: The method of any of aspects 24 through 28, wherein the UE-specific ID comprises a CAA-level ID that identifies the second UE.

Aspect 30: The method of any of aspects 24 through 29, wherein the DCR message excludes an application-layer ID associated with the service type.

Aspect 31: The method of any of aspects 24 through 30, wherein the broadcast message includes a set of proximity parameters associated with the second UE.

Aspect 32: The method of any of aspects 24 through 31, wherein at least one unicast message of the unicast messages comprises a unicast DAA message.

Aspect 33: A method for wireless communication by a first UE, comprising: establishing a communication link with a second UE according to a service type; communicating, with the second UE, a sidelink message indicating one or more parameters for communication of unicast DAA messages; and communicating, with the second UE, one or more unicast DAA messages according to the one or more parameters.

Aspect 34: The method of aspect 33, wherein the service type comprises an A2X service type.

Aspect 35: The method of any of aspects 33 through 34, wherein the sidelink message comprises a UAI sidelink message indicating one or more positioning parameters associated with the second UE, the one or more positioning parameters including a position of the second UE, a velocity of the second UE, a heading direction of the second UE, or a combination thereof, and wherein communicating the sidelink message comprises: receiving the UAI sidelink message from the second UE; and determining the one or more parameters for the communication of unicast DAA messages based at least in part on the one or more positioning parameters associated with the second UE.

Aspect 36: The method of any of aspects 33 through 35, wherein the sidelink message comprises a UAI sidelink message indicating the one or more parameters for the communication of unicast DAA messages, and wherein communicating the sidelink message comprises: receiving the UAI sidelink message from the second UE.

Aspect 37: The method of aspect 36, wherein the one or more parameters include a periodicity for the communication of the unicast DAA messages, a transmit power for the communication of the unicast DAA messages, or a combination thereof, and wherein communicating the one or more unicast DAA messages comprises: receiving the one or more unicast DAA messages from the second UE.

Aspect 38: The method of any of aspects 33 through 37, wherein communicating the sidelink message comprises: transmitting the sidelink message to the second UE.

Aspect 39: The method of aspect 38, wherein the one or more parameters include a periodicity for communicating the one or more unicast DAA messages, positioning information associated with the second UE to be included in the one or more unicast DAA messages, a trigger event for communicating the one or more unicast DAA messages, or a combination thereof, and wherein communicating the one or more unicast DAA messages comprises: receiving the one or more unicast DAA messages from the second UE.

Aspect 40: The method of any of aspects 38 through 39, wherein communicating the one or more unicast DAA messages comprises: transmitting, to the second UE, a request for a unicast DAA message of the one or more unicast DAA messages; and receiving the unicast DAA message from the second UE based at least in part on the request.

Aspect 41: The method of any of aspects 38 through 40, wherein communicating the one or more unicast DAA messages comprises: transmitting, to the second UE, one or more PRSs; and receiving the one or more unicast DAA messages from the second UE based at least in part on the one or more PRSs.

Aspect 42: The method of any of aspects 33 through 41, further comprising: transmitting, to the second UE, a first control message indicating a set of configurations for the service type; and transmitting, to the second UE, a second control message indicating that a configuration from the set of configurations is activated, the configuration including the one or more parameters.

Aspect 43: The method of aspect 42, wherein the first control message comprises an RRC message and the second control message comprises a MAC-CE message or an SCI message.

Aspect 44: The method of any of aspects 33 through 43, wherein the sidelink message comprises a UAI sidelink message indicating one or more positioning parameters associated with the first UE, the one or more positioning parameters including a position of the first UE, a velocity of the first UE, a heading direction of the first UE, or a combination thereof, and wherein communicating the sidelink message comprises: transmitting the UAI sidelink message to the second UE.

Aspect 45: The method of any of aspects 33 through 44, wherein the sidelink message comprises a UAI sidelink message indicating the one or more parameters for the communication of unicast DAA messages, and wherein communicating the sidelink message comprises: transmitting the UAI sidelink message to the second UE.

Aspect 46: The method of aspect 45, wherein the one or more parameters include a periodicity for the communication of the unicast DAA messages, a transmit power for the communication of the unicast DAA messages, or a combination thereof, and wherein communicating the one or more unicast DAA messages comprises: transmitting the one or more unicast DAA messages to the second UE.

Aspect 47: The method of any of aspects 33 through 46, wherein communicating the sidelink message comprises: receiving the sidelink message from the second UE.

Aspect 48: The method of aspect 47, wherein the one or more parameters include a periodicity for communicating the one or more unicast DAA messages, positioning information associated with the first UE to be included in the one or more unicast DAA messages, a trigger event for communicating the one or more unicast DAA messages, or a combination thereof, and wherein communicating the one or more unicast DAA messages comprises: transmitting the one or more unicast DAA messages to the second UE.

Aspect 49: The method of any of aspects 47 through 48, wherein communicating the one or more unicast DAA messages comprises: receiving, from the second UE, a request for a unicast DAA message of the one or more unicast DAA messages; and transmitting the unicast DAA message to the second UE based at least in part on the request.

Aspect 50: The method of any of aspects 47 through 49, wherein communicating the one or more unicast DAA messages comprises: receiving, from the second UE, one or more PRSs; and transmitting the one or more unicast DAA messages to the second UE, the one or more unicast DAA messages including positioning information associated with the first UE based at least in part on receiving the one or more PRSs.

Aspect 51: The method of any of aspects 33 through 50, further comprising: receiving a first control message indicating a set of configurations for the service type; and receiving a second control message indicating that a configuration from the set of configurations is activated, the configuration including the one or more parameters.

Aspect 52: The method of aspect 51, wherein the first control message comprises an RRC message and the second control message comprises a MAC-CE message or an SCI message.

Aspect 53: A first UE for wireless communication, comprising one or more memories storing processor-executable code, and one or more processors coupled with the one or more memories and individually or collectively operable to execute the code to cause the first UE to perform a method of any of aspects 1 through 7.

Aspect 54: A first UE for wireless communication, comprising at least one means for performing a method of any of aspects 1 through 7.

Aspect 55: A non-transitory computer-readable medium storing code for wireless communication, the code comprising instructions executable by a processor to perform a method of any of aspects 1 through 7.

Aspect 56: A second UE for wireless communication, comprising one or more memories storing processor-executable code, and one or more processors coupled with the one or more memories and individually or collectively operable to execute the code to cause the second UE to perform a method of any of aspects 8 through 13.

Aspect 57: A second UE for wireless communication, comprising at least one means for performing a method of any of aspects 8 through 13.

Aspect 58: A non-transitory computer-readable medium storing code for wireless communication, the code comprising instructions executable by a processor to perform a method of any of aspects 8 through 13.

Aspect 59: A first UE for wireless communication, comprising one or more memories storing processor-executable code, and one or more processors coupled with the one or more memories and individually or collectively operable to execute the code to cause the first UE to perform a method of any of aspects 14 through 23.

Aspect 60: A first UE for wireless communication, comprising at least one means for performing a method of any of aspects 14 through 23.

Aspect 61: A non-transitory computer-readable medium storing code for wireless communication, the code comprising instructions executable by a processor to perform a method of any of aspects 14 through 23.

Aspect 62: A second UE for wireless communication, comprising one or more memories storing processor-executable code, and one or more processors coupled with the one or more memories and individually or collectively operable to execute the code to cause the second UE to perform a method of any of aspects 24 through 32.

Aspect 63: A second UE for wireless communication, comprising at least one means for performing a method of any of aspects 24 through 32.

Aspect 64: A non-transitory computer-readable medium storing code for wireless communication, the code comprising instructions executable by a processor to perform a method of any of aspects 24 through 32.

Aspect 65: A first UE for wireless communication, comprising one or more memories storing processor-executable code, and one or more processors coupled with the one or more memories and individually or collectively operable to execute the code to cause the first UE to perform a method of any of aspects 33 through 52.

Aspect 66: A first UE for wireless communication, comprising at least one means for performing a method of any of aspects 33 through 52.

Aspect 67: A non-transitory computer-readable medium storing code for wireless communication, the code comprising instructions executable by a processor to perform a method of any of aspects 33 through 52.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive, from a second UE, a broadcast message that includes a UE-specific identifier that is unique to the second UE for an unmanned aircraft systems (UAS) traffic management (UTM) system;
transmit a direct communication request (DCR) message to the second UE in response to the broadcast message, wherein the DCR message comprises an application-layer identifier derived from the UE-specific identifier included in the broadcast message, a service type associated with information for communication with the first UE, or both; and
communicate unicast messages according to the service type with the second UE based at least in part on transmitting the DCR message to the second UE.

2. The first UE of claim 1, wherein the service type comprises an air-to-everything (A2X) service type.

3. The first UE of claim 1, wherein the broadcast message is a broadcast detect and avoid (DAA) message that further includes one or more positioning parameters associated with the second UE, the one or more positioning parameters comprising a position of the second UE, a velocity of the second UE, a heading direction of the second UE, or a combination thereof.

4. The first UE of claim 3, wherein the DCR message is transmitted to the second UE based at least in part on a metric determined from a trajectory of the second UE and the one or more positioning parameters associated with the second UE satisfying a threshold.

5. The first UE of claim 1, wherein the DCR message is transmitted as part of a unicast link establishment procedure with the second UE.

6. The first UE of claim 1, wherein at least one unicast message of the unicast messages comprises a unicast detect and avoid (DAA) message.

7. The first UE of claim 1, wherein the UE-specific identifier comprises a civil aviation administration (CAA) level identity that identifies the second UE.

8. A first user equipment (UE), comprising:
one or more memories storing processor-executable code; and
one or more processors coupled with the one or more memories and individually or collectively operable to execute the code to cause the first UE to:
transmit, to a second UE, a broadcast message that includes a UE-specific identifier that is unique to the first UE for an unmanned aircraft systems (UAS) traffic management (UTM) system;
receive a direct communication request (DCR) message from the second UE in response to the broadcast message, wherein the DCR message comprises an application-layer identifier derived from the UE-specific identifier included in the broadcast message, a service type associated with information for communication with the first UE, or both; and
communicate unicast messages according to the service type with the second UE based at least in part on receiving the DCR message from the second UE.

9. The first UE of claim 8, wherein the service type comprises an air-to-everything (A2X) service type.

10. The first UE of claim 8, wherein the broadcast message is a broadcast detect and avoid (DAA) message that further includes one or more positioning parameters associated with the first UE, the one or more positioning parameters comprising a position of the first UE, a velocity of the first UE, a heading direction of the first UE, or a combination thereof.

11. The first UE of claim 10, wherein the DCR message is received as part of a unicast link establishment procedure with the second UE.

12. The first UE of claim 8, wherein at least one unicast message of the unicast messages comprises a unicast detect and avoid (DAA) message.

13. The first UE of claim 8, wherein the UE-specific identifier comprises a civil aviation administration (CAA) level identity that identifies the first UE.

14. A method for wireless communication by a first user equipment (UE), comprising:
receiving, from a second UE, a broadcast message that includes a UE-specific identifier that is unique to the second UE for an unmanned aircraft systems (UAS) traffic management (UTM) system;
transmitting a direct communication request (DCR) message to the second UE in response to the broadcast message, wherein the DCR message comprises an application-layer identifier derived from the UE-specific identifier included in the broadcast message, a service type associated with information for communication with the first UE, or both; and
communicating unicast messages according to the service type with the second UE based at least in part on transmitting the DCR message to the second UE.

15. The method of claim 14, wherein the service type comprises an air-to-everything (A2X) service type.

16. The method of claim 14, wherein the broadcast message is a broadcast detect and avoid (DAA) message that further includes one or more positioning parameters associated with the second UE, the one or more positioning parameters comprising a position of the second UE, a velocity of the second UE, a heading direction of the second UE, or a combination thereof.

17. The method of claim 16, wherein the DCR message is transmitted to the second UE based at least in part on a metric determined from a trajectory of the second UE and the one or more positioning parameters associated with the second UE satisfying a threshold.

18. The method of claim 14, wherein the DCR message is transmitted as part of a unicast link establishment procedure with the second UE.

19. The method of claim 14, wherein at least one unicast message of the unicast messages comprises a unicast detect and avoid (DAA) message.

20. The method of claim 14, wherein the UE-specific identifier comprises a civil aviation administration (CAA) level identity that identifies the second UE.
